(19) United States
(12) Patent Application Publication
(10) Pub. No.: US 2026/0277642 A1
(43) Pub. Date: Sep. 17, 2026

(54) Computer-Based Method and Apparatus for Personal Assistance, Collaboration, Networking, and Providing Marketplaces

(71) Applicant: Mark L. Moeglein, Ashland, OR (US)

(72) Inventor: Mark L. Moeglein, Ashland, OR (US)

(21) Appl. No.: 19/554,636

(22) Filed: Mar. 2, 2026

Related U.S. Application Data
(63) Continuation-in-part of application No. 17/874,205, filed on Jul. 26, 2022, now abandoned.
(60) Provisional application No. 63/225,740, filed on Jul. 26, 2021.
(60) Provisional application No. 63/392,004, filed on Jul. 25, 2022.

(51) Int. Cl. G06F 9/451; G06F 9/54; G06Q 10/1093; H04L 67/306

(52) U.S. Cl. CPC G06F 9/453; G06F 9/542; G06Q 10/1093; H04L 67/306

(57) ABSTRACT

A method and apparatus to selectively allow communication and information exchange between a user and an ally in a networked communication system that includes mobile devices, laptop computers, and computers. The user selects from a list of relationship descriptors, and trust levels are designated responsive to the relationship descriptors. The list of relationship descriptors may include one or more high level group descriptors and lower-level descriptors. The user may select a privacy level, and responsive to the trust level and the privacy level, communication and information sharing are selectively allowed. The information shared may include user profile information, an ally list, favorites, shared interests, and calendars. A social fabric diagram may be created from which the user may view ally relationships.

### PRIORITY CLAIM AND CONTINUITY

This application is a continuation-in-part of prior, co-pending U.S. patent application Ser. No. 17/874,205, entitled Computer-Based Method and Apparatus for Personal Assistance, Collaboration, Networking, and Providing Marketplaces, filed Jul. 26, 2022.

Reference is made, and priority is hereby claimed to co-pending U.S. Provisional Patent Application No. 63/225,740 filed Jul. 26, 2021, entitled Method and Apparatus including Software for Personal Assistance, Collaboration, and Networking, and co-pending U.S. Provisional Patent Application No. 63/392,004, filed Jul. 25, 2022, entitled Computer-Based Method and Apparatus for Personal Assistance, Collaboration, Networking, and Providing Marketplaces, and co-pending U.S. patent application Ser. No. 17/874,205, filed Jul. 26, 2022 entitled Computer-Based Method and Apparatus for Personal Assistance, Collaboration, Networking, and Providing Marketplaces, all of which are incorporated herein by reference.

### BACKGROUND

### Technical Field

The disclosed method and apparatus relate generally to networked, computer-related personal time management systems, organizers, and marketplaces.

### Background

The internet, wireless communications and mobile computing have brought about a dramatic revolution in the way the typical person spends their time. Users tend to have either a smart phone or a computer (or both) with them at most times of the day, particularly when they choose to be connected and also when they desire to perform focused work. However, the same software ecosystem that supports connectivity can become distracting to a user who desires to perform focused work. Notifications appear to have become the Pavlovian bell of Web 2.0, training users to check their messages or social media apps, even if they are in the middle of a conversation or focused task. Phishing phone calls, SPAM e-mail, advertising or text messages are other forms of unwanted distraction. Social media platforms present the information most likely to capture a user's attention, not necessarily what a user might like to actually see. Focused ads steer users toward product purchases that are not typically in their best interest, but rather in the interest of the seller.

It is against this backdrop that we can see a user population that can behave largely like an addict. They are distracted and drifting through life, burdened by social pressures that are largely manufactured by the industry. They appear to be deeply unhappy, pained and checked out of their daily life, even as the friends and family that make up their social fabric look on with dismay. They are surly and difficult to reach, with a closed heart and a closed mind.

Our solution to this societal malaise is trustworthy personal assistant software meant to help the user become equally trustworthy, safe, and reliable. It provides the user with the tools required to feel through their discomforts and act with intention, to become happy, equanimous, and pain-free. It also provides the user with the ability to connect with those same friends and family that they may have been missing all along, allowing them to keep an open mind and heart, showing up with love and kindness for all.

For the software or “app” to provide good utility for each user, it also should be of use to their allies. For this reason, it should be affordable, preferably free, and easy to use. It should give the user the information they need at any given moment to stay oriented in time and intent, and limit what might distract them. It should also make it possible for them to transmute their discomforts into positive intentions, with the tools to translate those intentions into actionable steps, to form ever-more-positive habits and let go of those habits that don't serve them anymore.

In short, the app should not only be free and ad-free, but it should also be a powerful tool for users to regain control of their lives. To accomplish these goals, the software may use peer-to-peer networking technology to form supportive social circles, because cloud-based topologies can become expensive to maintain and are largely unnecessary for this purpose. It may operate on multiple devices per user, providing most of the same functionality on the typical user's smart phone as it does for a work or home computer and mirroring changes made on one device to all of the user's devices running the app.

Many software products have been developed for the purpose of improving productivity, managing time, and generally providing assistance to executive functions. Early software products and other contributions in the field of executive function software included contact management, on-line calendars, and mindfulness tools. Examples of current calendar programs include Apple Calendar and iPhone Contacts, Google Calendar, Calendly, and Fantastical. Examples of email and messaging programs include: Yahoo! Mail (previously RocketMail), HotMail, Gmail, Facebook Messenger, and Apple Messages. Examples of Mindfulness apps include: Mindfulness Bell, Woop, Headspace and Calm. A number of software programs implement various combinations of contacts, messaging, and scheduling such as Microsoft Outlook, Facebook and Google's Suite headlined by gmail. Examples of related software programs include: Apple iOS, expert contact apps like WhenHub, family organizer apps like Cozi, CRM and productivity software, as a class, such as Zoho, weight loss apps such as Noom, sharing economy applications such as Airbnb, Uber, and Lyft, online marketplace apps such as eBay, Etsy, Craigslist, and Amazon, delivery apps such as DoorDash, Instacart, UberEats, relationship management and booking apps such as ourFabriq, Superpeer, Calendly and Acuity, and timer apps, such as BreakTime tool in Parallels Toolbox software. P2PFoundation and the offers and needs marketplaces advocated by the Post Growth Institute have also served as a source of inspiration.

Networked mobile devices such as cell phones, tablets, and laptop computer provide a nearly unlimited ability for people to communicate in real time and share information. However, the downside of this widespread real-time communication ability is distraction, and time spent on matters that may not be important or useful. Numerous publications have addressed this issue in the context of productivity and time management, such as Hooked and Indistractible by Nir Eyal, Marydee Sklar's executive function training materials and books known collectively as, “Seeing My Time.” Also, the writings of British anthropologist Robin Ian MacDonald Dunbar are relevant.

Accordingly, there is a need for methods that protect a user from unwanted distractions from mobile phones, tablets, computers, and other devices, and yet supports communication with sources desired or beneficial to the user.

### SUMMARY

In order to promote user focus, improve executive function, and protect privacy, personal growth a method is disclosed that sets up an ally relationship, determines trust levels between the allies, and selectively allows communication between allies based upon trust levels, thereby preventing unwanted communications and avoiding unnecessary distractions that could otherwise sap energy and waste time.

Various embodiments of the method and apparatus are disclosed. In one embodiment a method is disclosed for a user to designate trust levels to facilitate communication and sharing information between the user and an ally, including displaying to the user a list of relationship descriptors for the ally, selecting at least one descriptor by the user, and determining a trust level responsive to the selected descriptor. The selected trust level is stored in the user's profile associated with the ally, and the stored trust level is then utilized to selectively share the user's information with the ally responsive to the stored trust level. The list of relationship descriptors may include a high-level group descriptor selected by the user, such as Family, Friend, Business and Neighbor groups. The user may select a privacy level, which is then stored in the user's profile. Responsive to the trust level and the privacy level, communication and information sharing are selectively allowed. The information shared may include user profile information, an ally list, favorites, shared interests, and calendars.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 is a block diagram of a network that includes a plurality of devices connected for communication.

FIG. 2 is a flow chart illustrating steps of forming an ally relationship between a first and a second user.

FIG. 3 is a table that shows an example of quantitative and qualitative levels of discovery.

FIG. 4 is an example of an ally window.

FIG. 5 is a flow chart that illustrates operations to designate trust levels and selectively share information responsive to the trust levels.

FIG. 6 is a table that shows one example of relationship group descriptors, and associated quantitative and qualitative trust levels.

FIG. 7 is a table that shows one example of privacy levels such as a user may select.

FIG. 8 is a table that shows an example of trust levels and information visibility across multiple relationship types.

FIG. 9 is a table that shows an example of Relationship Types, Descriptors and Associated Trust Levels.

FIG. 10 is a table that shows an example of Quantitative and Qualitative Descriptions of Trust Levels.

FIG. 11 is an example of a social fabric diagram.

FIG. 12 is an example booking form.

FIG. 13 is a table that shows an example of mapping between Quantitative and Qualitative Focus Levels.

FIG. 15 shows an example of a time-boxed calendar.

FIG. 16 is a table that shows an example of a naming table that defines which days of the week match a particular calendar template.

FIG. 17 is a table that shows an example of a time-boxing table useful for allocations.

FIG. 18 shows an example of a day plan.

FIG. 19 is an example of a home screen.

FIG. 20 is a flow chart illustrating a method for coordinating information sharing on a user device.

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

### (1) Implementations

The features and methods described herein can be implemented in one or more software programs which can be operated on a computer, a mobile device, or any computing device. This software program, or programs, may be referenced herein collectively as “software” or “application” or “app”. An “app” includes programs that run on mobile devices, laptops, and personal computers, and are operated by a user.

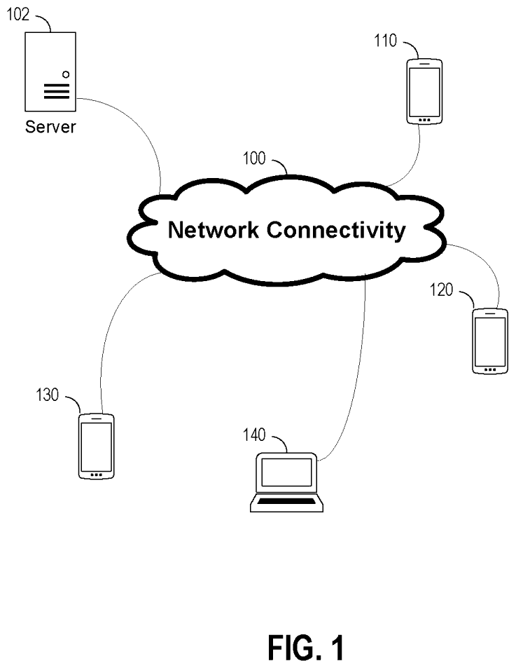

FIG. 1 is a block diagram of a network that includes a plurality of devices connected by any suitable network connectivity system 100, such as wireless, wired, or Ethernet. The networked devices include a server 102 that includes software programs, a first mobile device 110, a second mobile device 120, and a third mobile device 130, and a laptop computer 140.

### (2) Overview

A computer-implemented coordination system is described that includes a user device including at least one processor and a non-transitory computer-readable medium storing instructions that are executed by the at least one processor. The coordination system causes the user device to store coordination information associated with a user, the coordination information including: profile information including relationship-specific parameters for a plurality of allies, the relationship-specific parameters including, for each ally a relationship type and a trust level, stored message information, and a multi-layer calendar stored on the user device. The multi-layer calendar including a time-box layer defines a plurality of time-boxes collectively forming a day plan for the user. Each time-box includes time-box parameters defining a contextual state of the user during that time-box. The time-box parameters include an associated intention, and an associated focus level. At any given time within the day plan, one and only one time-box is applicable to the user. The coordination system also operates to identify a current time-box of the plurality of time-boxes, and evaluates coordination information in association with a selected ally based at least on the relationship-specific parameters associated with the selected ally and the time-box parameters associated with the current time-box. The coordination system also determines responsive to the evaluation, whether and how the coordination information is to be accessed, displayed, transmitted, or suppressed. This evaluation and the determination are performed entirely on the user device. The coordination system also selectively performs, by the user device based on the determination, at least one system operation such as one or more of: transmitting all, a subset of, or none of the coordination information or information derived therefrom to the selected ally using peer-to-peer communication, displaying all, a subset of, or none of the coordination information or information derived therefrom to the user, generating a notification to the user regarding the coordination information or information derived therefrom, the notification having a modified presentation characteristic including at least one of content, prominence, timing, or modality, and displaying the selected ally in a prioritized position, a deprioritized position, or not at all within a displayed list of allies on the user device.

The coordination system can also determine availability. The coordination information may include availability information derived from the time-box layer, the availability information being distinct from full calendar event information. At least one system operation can selectively transmit to the selected ally, responsive to the relationship-specific parameters, at least one of full calendar event information, availability information without event detail, and no calendar-related information. The calendar-related information transmitted to different allies may differ according to their respective relationship-specific parameters. The evaluation, for the selected ally and for the identified time-box, can determine an ally-specific availability state based on the intention associated with the identified time-box and the relationship type associated with the selected ally. The evaluation, for the selected ally and for the identified time-box, may determine an ally-specific interruptability level based on the relationship type associated with the selected ally and the intention associated with the identified time-box, and may control whether synchronous communication from the selected ally is presented immediately, modified, or deferred responsive to the determined ally-specific interruptability level.

The coordination system may also implement message sharing. In this embodiment, the stored message information may include a message associated with the user, and the determination determines, for a selected ally, whether and how the message is transmitted to a selected ally device or displayed on the user device.

The coordination system may also implement notifications. In this embodiment, the time-box parameters further include an interruptability level associated with the time-box, the interruptability level being either an independently defined time-box parameter, or derived from one or more other time-box parameters. The at least one system operation may suppress generation of the notification during a time-box having low interruptability level. Notification may be deferred for presentation during a time-box having higher interruptability. At least one of timing, modality, or prominence of the notification may be altered responsive to the interruptability level associated with the identified time-box. Timing, modality, or prominence of the notification may escalate from a first notification level during a first time-box having lower interruptability level to a second notification level during a subsequent time-box having higher interruptability level.

The coordination system may also implement offer or request gating. In this embodiment, the coordination information may include offer information or need information associated with the user. The offer information or need information may include visibility metadata specifying one or more relationship types or trust levels permitted to access the offer information or need information. Transmission of the offer information or need information to the selected ally may be permitted only if the relationship-specific parameters of the selected ally satisfy the visibility metadata.

The coordination system may also implement calendar architecture reinforcement. In this embodiment, the time-box layer may at least one stored day plan template defining a plurality of time-boxes reusable across multiple calendar days. The system may assign a selected day plan template as a default for one or more days of the week and permit the default assignment to be overridden for a specific calendar day or date range.

The coordination system may also implement a multi-layer calendar structure. In this embodiment, the multi-layer calendar may further include an event layer distinct from the time-box layer.

The coordination system may also implement a neighbor-like functionality. In this embodiment, the profile information associated with the user may include first stored location information and the profile information associated with the selected ally, and further include second stored location information. In this embodiment, evaluation may further comprise evaluating proximity between the user and the selected ally based at least in part on the first stored location information and the second stored location information in combination with the relationship-specific parameters associated with the selected ally and the time-box parameters associated with the current time-box. Determination of whether and how the coordination information is accessed, displayed, transmitted, or suppressed may be responsive to the evaluated proximity.

A computer-implemented method is described for coordinating information sharing on a user device that includes at least one processor and a non-transitory computer-readable medium. The method includes storing, on the user device, coordination information associated with a user. The coordination information includes profile information including relationship-specific parameters for a plurality of allies. The relationship-specific parameters may include, for each ally, a relationship type and a trust level, stored message information; stored location information; and a multi-layer calendar including a time-box layer defining a plurality of time-boxes collectively forming a day plan for the user, each time-box including time-box parameters defining a contextual state of the user during that time-box, the time-box parameters including an associated intention and an associated focus level. At any given time within the day plan, one and only one time-box may be applicable to the user.

The method may include identifying, by the at least one processor, a current time-box of the plurality of time-boxes, evaluating, by the at least one processor, coordination information in association with a selected ally based at least on the relationship-specific parameters associated with the selected ally and the time-box parameters associated with the current time-box, and determining, by the at least one processor and responsive to the evaluating, whether and how the coordination information is to be accessed, displayed, transmitted, or suppressed. The evaluating and the determining steps may be performed entirely on the user device. Based upon the evaluation and determination, at least one system operation may be selectively performed. These system operations may include one or more of transmitting all, a subset of, or none of the coordination information or information derived therefrom to the selected ally using peer-to-peer communication, displaying all, a subset of, or none of the coordination information or information derived therefrom to the user, generating a notification to the user regarding the coordination information or information derived therefrom, the notification having a modified presentation characteristic including at least one of content, prominence, timing, or modality, and displaying the selected ally in a prioritized position, a deprioritized position, or not at all within a displayed list of allies on the user device.

A non-transitory computer-readable medium is described that stores instructions that, when executed by at least one processor of a user device, causes the user device to perform operations including storing coordination information associated with a user. The coordination information may include profile information including relationship-specific parameters for a plurality of allies, the relationship-specific parameters including, for each ally, a relationship type and a trust level, stored message information, stored location information; and a multi-layer calendar including a time-box layer defining a plurality of time-boxes collectively forming a day plan for the user, each time-box including time-box parameters defining a contextual state of the user during that time-box. The time-box parameters may include an associated intention and an associated focus level. At any given time within the day plan, one and only one time-box may be applicable to the user in a preferred embodiment. The non-transitory computer-readable medium also stores instructions to identify a current time-box of the plurality of time-boxes, evaluate coordination information in association with a selected ally based at least on the relationship-specific parameters associated with the selected ally and the time-box parameters associated with the current time-box, and determine, responsive to the evaluation, whether and how the coordination information is to be accessed, displayed, transmitted, or suppressed. In the preferred embodiment the evaluation and the determination steps are performed entirely on the user device. Based on the determination, at least one system operation may be selectively performed, including one or more of transmitting all, a subset of, or none of the coordination information or information derived therefrom to the selected ally using peer-to-peer communication, displaying all, a subset of, or none of the coordination information or information derived therefrom to the user, generating a notification to the user regarding the coordination information or information derived therefrom, the notification having a modified presentation characteristic including at least one of content, prominence, timing, or modality, and displaying the selected ally in a prioritized position, a deprioritized position, or not at all within a displayed list of allies on the user device.

### (3) Ally Relationship Overview

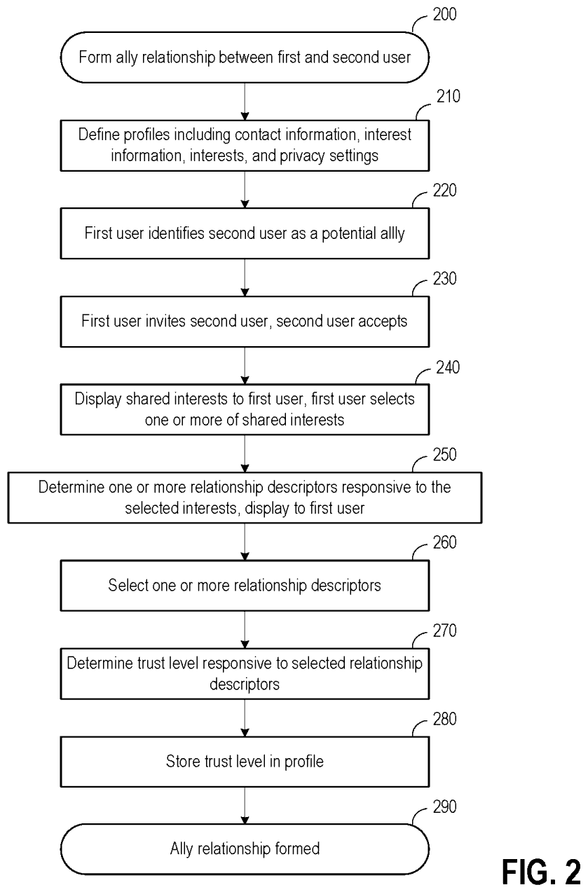

FIG. 2 is a flow chart illustrating steps for forming an ally relationship between a first and a second user (STEP 200). Each of the users first create an account and then define their profile in the app (STEP 210). The profile includes contact information, interests, privacy settings, and other information. Profiles are described in more detail in this specification, for example in Section (3).

The first user searches for a potential ally and identifies the second user as a potential ally (STEP 220) using any of a variety of criteria. Searching for potential allies is described in more detail, e.g., with reference to Section (4)

The first user invites the second user using any suitable communication means such as a text message or email and then the second user accepts the invitation, and sends an acceptance to the first user using either the same communication means or via peer-to-peer messaging functionality built into the app. (STEP 230).

The app, which has access to the interests of the first and second user, determines potential interests shared between the first and second users. Alternatively, or in addition it may rely upon the first user to state the interests shared between the two users, and displays the shared interests to the first user, who then selects one or more of the shared interests. (STEP 240). The app may also display the shared interests to the second user, who selects one or more of the shared interests. For example, a first and second user may have the same parents. If the app knows this, it might suggest that they are siblings of the same family.

Responsive to the selected interests of the first user, the app determines one or more relationship descriptors, and displays them to the first user. (STEP 250). In the above sibling example, the app may know that the first user is a woman and the second is a man, and so the suggested relationship descriptors would be family/brother and family/sister, where family is termed the high level relationship descriptor and sister and brother are considered low level relationship descriptors and their shared interest is their family of origin. The app may also determine relationship descriptors and display them to the second user responsive to the selected interests of the second user. Relationship descriptors are described in more detail with reference to Section (7), for example. In our brother and sister example from above, the second user (the brother) would be asked to confirm the relationship.

The first user then selects one or more of the displayed relationship descriptors (STEP 260). The second user may also select one or more of the relationship descriptors displayed to the second user. For example, in addition to family, they may consider each other friends. So further to our example, one might select friends/best friend and the other friends/close friend, forming a slightly unbalanced relationship.

Responsive to the relationship descriptors selected by the first user, the app determines the trust level of the first user (STEP 270) relative to the second user. The app may also determine the trust level of the second user relative to the first user, responsive to the relationship descriptors selected by the second user. Determining the trust level responsive to the relationship descriptors is described in more detail, e.g., with reference to Section (5).

The trust level determined for the first user is then stored in the first user's profile (STEP 280). The trust level determined for the second user may be stored in the second user's profile.

At that point an ally relationship has been formed (STEP 290). The trust levels determined by the app, and the privacy settings defined by the users can now be utilized to selectively manage and control communications (e.g., messages and notifications) and selectively allow access to the other ally's profile information.

### (4) User Profiles

### Creation

After creating an account in the app, each user will create a profile that preferably starts with the basic information and allows them to populate their profile in the app very quickly (many entries may be optional). A user's profile may be updated at any time while the user has a valid account. Initially, the profile can be very simple (e.g., name, privacy, email and mobile phone number.) Typically, the combination of name and either e-mail address or phone number is required to be unique, and if there is a match to a pre-existing account and the user has forgotten their login credentials, the app can make it easy for them to recover those credentials with some form of two-factor authentication. This should be selectable by each user, according to how tight they want their security. If they select built-in password safe functionality, the app may automatically tighten security. Also, the app may implement a means for a third-party authentication, for example via close allies.

A profile menu bar may be available to set or modify the user's profile, for example allowing a user to:
1. Import multiple allies from existing contact lists.
2. Import external calendars (layer 3).
3. Jump to values short course.
4. View/Edit Individual Profile Items (addresses, usernames, resume info, etc.)
5. Offers and Needs:
   a. Co-Work
   b. Co-Socializing
   c. Co-Exercise
   d. For Sale
   e. Help Wanted
6. Export ally contact phone numbers into a phone device's contact list, to allow user to view a name with the phone number of an incoming call and, with phone privacy features, provide for smarter decision making regarding the use of phone rings (notifications).

### User Profile Information

Below is a list of some of the information that may be entered into user profile fields by a user:
First Name, Middle Name, Last Name (pre-existing),
Short name (preferably five characters or less, for display) (pre-existing),
Mobile phone number (pre-existing),
Home phone number (optional),
Work phone number (with or without extension) (optional),
e-mail address(es) associated with work, home, etc. (pre-existing),
Preferred modes of communication (may be focus-level dependent, so it can be delivered in near-real-time to allies for their reference),
social media address(es)/handle(s) (optional),
physical address(es) (optional),
snail mail address(es) (optional), and
Date of birth (mandatory).

The user may provide additional information in the user profile such as background information, personal information, interests, and what might be found in a resume (may be optional on first pass, but mandatory for yellow pages)
List of schools and years attended
List of degrees earned from post-secondary schools
List of other certificates/classes taken
List of jobs and years worked
List of notable skills
Personal descriptors (desirable): Height, weight, hair color, eye color, enneatype (implicit or explicit), Myers-Briggs, etc.
Devices and Server Addresses
Private information, kept securely and accessible only to permitted allies: credit card numbers, health insurance info, health history, account details (password safe), social security number, frequent flyer numbers, pricing information, and so forth, and
Favorite restaurants, shopping locations, news sources, entertainment sources, local services (grocery store, dog grooming, barber, mechanic, drug store, etc.), movies, games, sports teams.
The profile may include present device location, where available, or planned trajectory with appropriate controls for trust, privacy and shared interests.

The optional information can be useful for particular purposes (e.g., Collaborations) and because it is optional, the user may not be required to enter it into the profile during the initial onboarding process but can do so later. Preferably, these entries should be asked one at a time, with the ability to just click through to the next.

### Intentions for Relationships

The user may indicate intentions for relationships with allies. Examples of intentions for relationships may include:
automated time suggestions
Fixed amount of time per (week/month/year)
Desire to schedule (one-off/ad hoc)
Desire to invite into a certain relationship type, when both sides are available (e.g., a shared activity such as playing music, tennis or pickle ball together).

### User Access to Software Tools

An app menu bar profile menu may be made available for the user, allowing them to, for example: 1. import multiple allies from existing contact lists, 2. import external calendars (layer 3), 3. jump to menu of short courses, 4. view/edit Profile, or 5. edit Offers and Needs, e.g.,: Co-Work, Co-Socializing, Co-Exercise, Co-Shopping, Co-Walking, or it may be User-definable.

The user may define a wide range of information that can be utilized to facilitate effective communication with allies, and for other purposes. For example:
The user may define the type of collaboration activity allowed with allies and others.
A user may specify a level of introversion or extroversion by indicating an optimal group size or range of sizes for each type of group or a particular group search. This may be used when a user is searching for groups to prioritize the search results.
The user may designate intentions in the profile. Intentions may include a list of habits the user wishes to make and habits they wish to break.

### Marketplace Listings

Once a profile has been created, a user may list items in a marketplace that may be private or public. Marketplace listings may include any listing the user chooses to make available in the marketplace, whether it is marked for the private marketplace (among allies), public marketplace, or both. If it is marked for the private marketplace only, the user may specify who among their allies may see the listing based upon either explicit selection or based upon filters such as group or trust level. The user may be able to send a notice of the listing to selected allies, and those allies may be able to decide if and when they choose to be notified of such a listing, when they choose to read it and when they choose to respond to it. The ally may be able to change the trust level of the relationship upon receiving the notice, upon reading it, or at any time. They may also be able to indicate that they prefer to see more or less of such information from either that specific user or in general. In the former case, a notation may be made with regard to that ally or their trust level modified. In the latter case, one or more of the user's privacy levels may be modified.

### (5) Allies

Relationships with Allies

Once a user profile has been created, one or more allies may be added.

A relationship or alliance is a particular type of connection existing between people related to or having dealings with each other. Users may specify one or more relationships with each ally. For example, a family member may also be a friend, business partner, neighbor and share several interests. In such case, the app would treat each of these relationships distinctly but make sharing decisions based upon the highest levels of trust and associated shared interest. For example: a user might specify their spouse as also their best friend, but not a business associate. Thus, the spouse might, for example, be afforded maximum visibility into the user's calendar information during personal times, but only availability information during work times.

With the addition of each new ally comes the ability to invite some fraction of their allies, according to what is appropriate to both sides of the transaction.

In one embodiment, before adding an ally, a user may first enter their profile information. The user is the first ally on their own diagram. We can call this screen “[User]'s Hub”, where the user's first name is used, for example, if a user's name is John, then the screen may be titled, “John's Hub”. Hitting the “+” button prompts the user for new information at the bottom of the screen, scrolling down, as necessary.

The first time a user hits the +button, the user is prompted to enter at least some fraction of their own profile information. In some embodiment name and either phone number or e-mail address is the minimum information required to assure a unique fit.

In some embodiments a validated unique phone number may be required to fully trust that a particular ally is not a bot. The same approach applies to users sharing a home or business phone. Validating an e-mail address can be an additional enhancement, although it may not be as “trust-worthy” as a phone number. Each user should be unique, but we will encourage users to fully flesh out their profiles. A user who has not entered and validated a phone number can be considered a potential bot, until proven otherwise. An algorithm can be implemented to estimate the likelihood of being a bot.

### Searching for an Ally

Selecting the +button a second time may start the process of searching for one or more allies. To search for allies, a neighbor search may utilize a proximity filter, as well as shared interest filters, whereas a business-oriented search might utilize and focus upon specific offers or needs in one or more categories, such as that seen on Craigslist or Amazon. Or it may focus upon a known business contact's name, company name, phone number, e-mail address, etc. A family filter might focus upon a given last name, first name, age, date of birth, or any of a number of search terms as might be seen on a genealogy software search such as those provided by Geni, MyHeritage, WikiTree, etc. These would typically include first name, last name, birth name, date of birth, date of death, living or deceased, birth location, death location, residence and/or reference to any other family member (e.g., John Doe's with at least one child). One of the challenges of these genealogy services is that they do not make it easy to find living relatives, considering them private, and they do not make it easy to contact living relatives. The app may help families to connect with each other by brokering trusted relationships, allowing, for example, willing cousins to connect with each other and then introducing more distant cousins.

### Discoverability

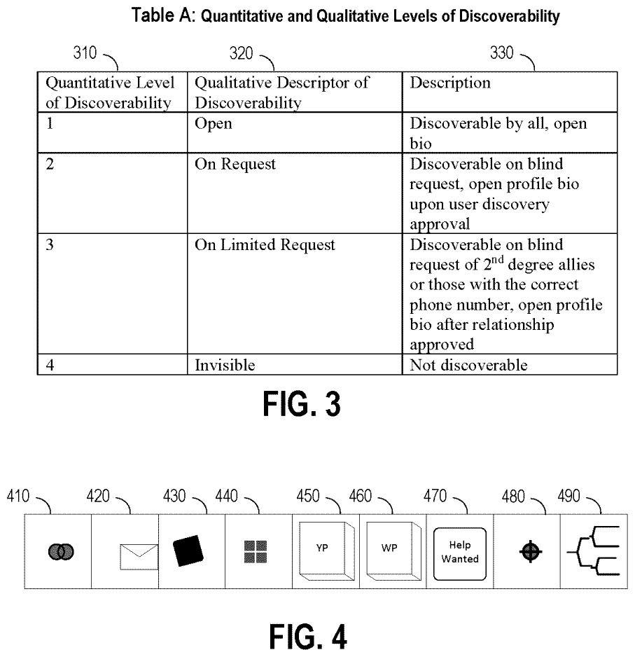

Table A (FIG. 3) is an example that shows levels of discovery; particularly showing quantitative level of discovery 310, qualitative levels of discovery 320, and associated description 330. Discoverability is a more specific privacy descriptor, intended to describe the user's openness to being “found” by other users. Discoverability may be set globally, such as for high level groups or even for low level groups. For example, a famous user may use a global “Invisible” discoverability setting and then set their discoverability to “On Limited Request” for certain familial relationships and certain business relationships. Some users, such as those being harassed, in the public spotlight or simply overwhelmed with too many allies may choose the “Invisible” setting across all high-level groups and relationship types, meaning that they are effectively invisible to potential allies.

However, in some embodiments any users may use level 2 or 3 to limit discoverability to only blind requests. A blind request is sent to all users matching a certain potential ally search. The searcher does not immediately know who the request went out to or how many potential allies it went to. Upon receiving a blind request, the receiving user would either immediately be presented with their relevant choices, or the request would be queued for a later time that the user had set out for reading messages, based upon the user's current focus level and time usage intention. The user may approve or disapprove the request. If they approve the request, the searcher would receive an indication of their discoverability. If they do not approve the request, the searcher would not receive any information.

Discoverability may be set according to a user's privacy settings, discoverability may be explicitly set by the user, or a default or suggested discoverability setting may be set based on privacy settings, allowing the user to change it. The user may be prompted for confirmation of this form of provisional or conditional setting.

### Shared Interest Groups

A user may find allies through shared interest groups. Shared interest groups may have different search features than individual ally search features. Shared interest group search features may vary depending upon their size and nature, with certain features settable by the group owner, such as searchability of prior messages, membership, within profiles of the membership, prior and future group collaborations, etc.

Shared interest groups may be the default groups (friends, family, neighbors, and business) or they may be other groups stemming from membership in any form of organization, whether informal or formal.

These groups may be subsets of the default groups or may have their own particular mix, according to shared interests. Shared interests may include, for example:
1. Neighbor/Church
2. Neighbor/Clubs
3. Neighbor/School
4. Company/Work
5. Neighbor/Hobbies/ . . .
6. Friend/Hobbies/ . . .
7. Neighbor/Sports/ . . .
8. Neighbor/Running
9. Health/Medical condition
10. Business/Food.
11. Business/Clothing
12. Business/Utilities
13. Business/Construction/Framing Carpenters
14. Family/TheJoneses

In each case, the creator of a group will become its moderator, and each member must be invited or join through a group directory, similar to those known in the art. The group may be private or public, wherein a private group might be limited to only those who are trusted to a certain level for the group owner. Group members may be able to recommend or vouch for a potential new member, or potential new members may see the listing of a public group discovered through their search and request to join.

Group messaging will be handled in a manner similar to inter-ally messaging, generally with low default urgency, unless the group has a high sense of importance to a given member receiving the message.

Users may be able to browse available public neighbor groups by proximity, locale, shared interest, default group, or shared interest key words, where the locale may be designated at various levels of government (e.g., city, county, state, country, continent) or, for example, certain bands of latitude.

### Adding Allies

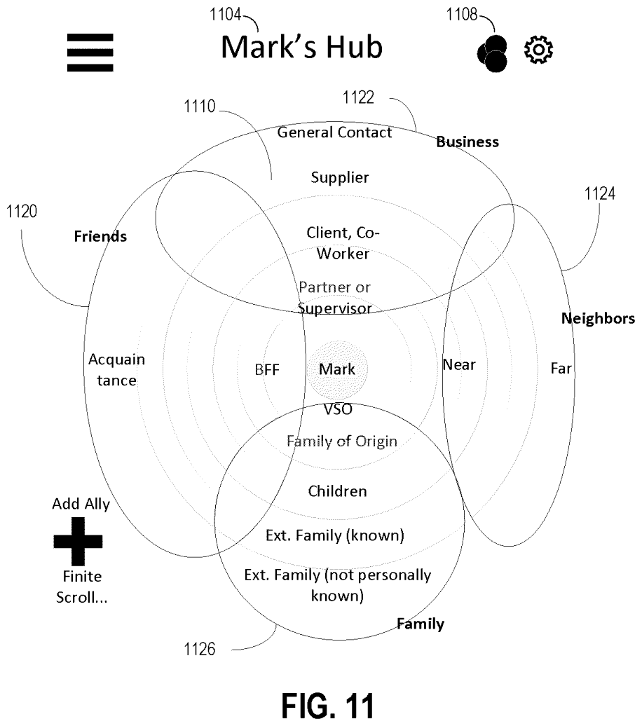

For description purposes, we will focus on adding a single ally; the same may also apply to the import process, and/or adding an ally group. Preferably a user is asked to enter enough information about their desired ally to resolve ambiguity with reasonable probability (first degree allies) with autocompletion when possible, or at least some indication that they have entered enough information. The user may also provide information regarding the relationship and where the ally fits on the Social Fabric Diagram (FIG. 11) or, at a minimum, their shared high-level group or shared interest group.

After two users each agree to be allies, they are validated within their circle and can then exchange appropriate members of their respective allies, choosing those ones from each other's lists that they would like to become allies with and sending out invitations to connect, as appropriate. This approach has several benefits, such as the following.

Each user controls their own address information, so if they change addresses, everyone else will have access to their new address automatically. All their allies really have, by default, is a pointer to their ally information, not direct access to that information.

Users need only enter a minimum of information, benefitting from connection to others that are committed enough to do that work, themselves.

Duplicates can be managed at the application level, making sure that people are unlikely to have multiple accounts. (Business accounts will still, ultimately, be associated with the business owners' yellow page/offer listing.)

The import process, then, may simply be a matter of choosing who to invite to be a conscious connection and adding some information about shared context beyond the default. For example, a friend of a friend is usually a friend, but they might be more of a business associate or even family member. So, the user must be able to override the default.

Everyone can control their own privacy, and it will be easy to claw back more privacy when overwhelmed. For example, a famous person might select “most private”, whereas an epicure might choose “most public”, with a range of selections in-between. Each user could modify their privacy settings to suit their current situation, for example relaxing to more public when on vacation and then more private when doing focused work. These settings may be adjusted according to the users' layer 2 calendar intention, as well. (e.g., during focused work, mark me as private).

The ally search process may be along the lines of a certain name, a shared interest, a given locale or proximity, or any of several other possible filtering mechanisms. These searches may have a different flavor for each type of shared interest group.

### Ally Window and Functions

FIG. 4 shows an example of an ally window. Clicking on, tapping on, or otherwise selecting an ally in the above figure brings up a pop-up ally window with several choices on a selection bar, something like this:

Many ally functions can be implemented in the ally window as shown in FIG. 4. In order from left to right, when selected the appropriate details about the ally would be displayed:
Relationship 410: Name, Contact Info (all that user has permission to see), Trust Level, Shared Interests, Current Status;
   Messages 420: Shared message history (and ability to send a new message);
   Collaborations 430 (past, present and/or future): Titles, Times, Places, Notes, Context;
   Time-Box Calendar 440 Layer 2: Display ally's time usage table or calendar templates and allow user to adopt some or all of it (relates to Personal Intentions);
   YP 450 (ally offers): Yellow Pages: What the ally has to offer for pay; and
   WP 460: White Pages: What the ally has to offer without pay; (relates to Personal Intentions)
   Help Wanted 470 (ally needs): The amount the ally is willing to pay; and
   Family Tree Diagram 480, displaying family members in a manner similar to the social fabric diagram, only arranged by family relationship.
   List of Ally's allies 490, as allowed for by the privacy, trust and shared interests of the ally and their allies.

A magnifying glass icon (or similar) may be added to the social fabric page, allowing for white page, yellow page, family tree or friend searches. Each of these searches will have a different character.

The term “permission” is defined broadly to include explicit and implicit permissions, where implicit permissions are typically based upon a user's stated privacy level, the selected one or more relationships with an ally, and a level of shared interest, where a shared interest may be associated with belonging to the same group or organized around a private or public marketplace offer. If the permission is being determined in association with a private marketplace offer, it must be, by definition, between two allies, with a certain jointly determined level of trust. However, if it is associated with a public marketplace offer, a software-provided trust level for each party may be used instead, said trust level associated with such metrics as time of membership, number and quality of reviews, number of allies of both parties, number of positively reviewed transactions, number of negatively reviewed transactions, or the ratio of the two. Only information relevant to the transaction would be shared in a public marketplace communication, typically focused upon the offer listing and not so much upon the associated offeror.

In those countries where the term “Yellow Pages” is unavailable (e.g., trademarked), an alternative term, such as “Offers” may be substituted without changing the behavior of the app.

### Other Ally Relationship Types

As an extension to our standard ally relationship types, we may include, for example, these important unbalanced relationships, or other, similar, archetypal relationships, such as Idol/Fan, Teacher/Student, Mentorship (e.g., big brother/big sister, industry experience, general to any special interest), AA Sponsor/Member, Health Care Provider/Patient, Seller/Buyer, Subscription Owner/Subscription User, or Technical Support/User.

The app may have templates for how these relationships can best function, allowing users to select these relationship types and their default settings. All relationships will be held in strict confidence, with peer-to-peer communication and device-based security providing a strong case for privacy and straightforward communication. This is important for sensitive relationships where privacy is a concern for either or both sides of the relationship. It is also very much needed in this age of analytic data and address lists being sold without a user's permission.

### (6) Trust Levels

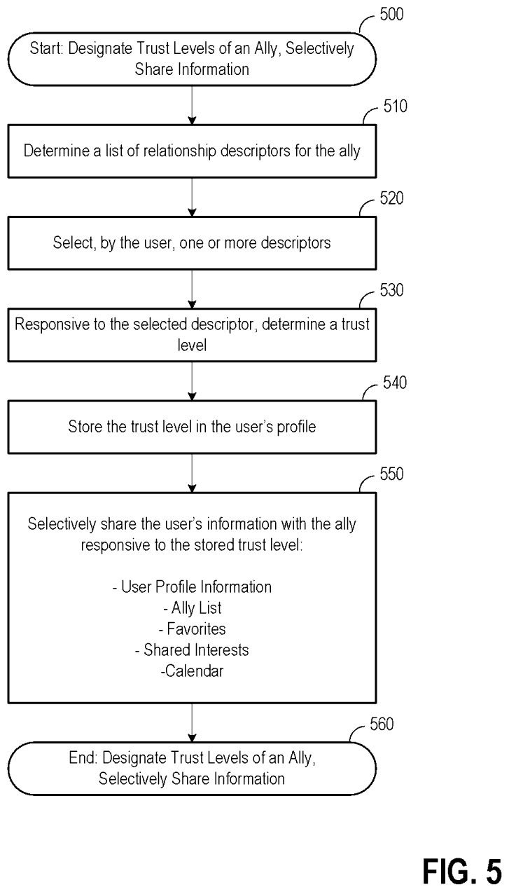

FIG. 5 is a flow chart that illustrates operations to designate trust levels and selectively share information responsive to the trust levels. Operations begin (STEP 500), and then a list of relationship descriptors is determined for the ally (STEP 510). The user then selects one or more of the determined descriptors (STEP 520). Responsive to the selected descriptor, a trust level is determined (STEP 530), and the trust level is stored in the user's profile (STEP 540). Next a request may be made to share information, or any communication may be requested, and the user's information can be selectively shared with the ally, dependent upon the trust level. (STEP 550) The user's information that may be shared may include user profile information, one or more ally lists, favorites, shared interests, and a calendar.

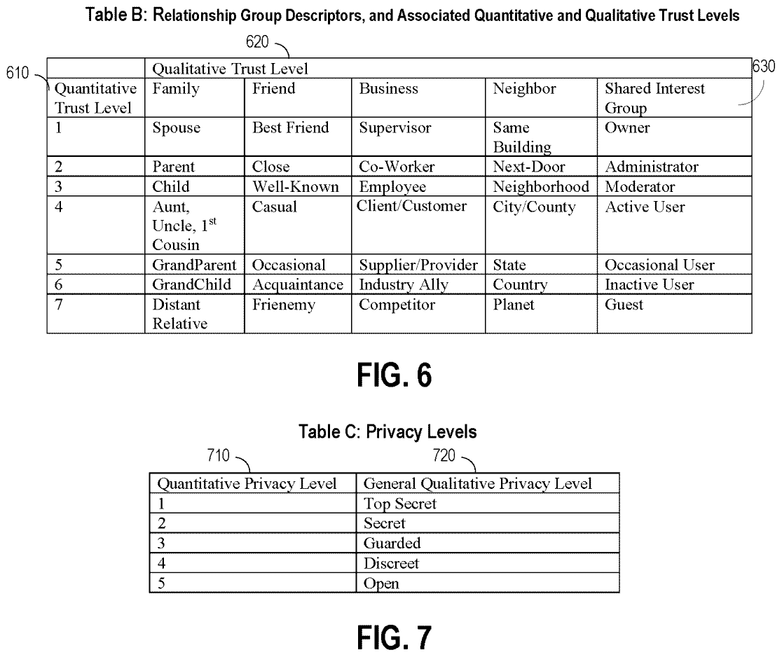

A trust level of a potential ally is set responsive to the user's profile information and entries made by the user. Table B (FIG. 6) is a starting point for specifying levels of trust. Below is an example of how levels of trust may be specified both when an alliance is proposed and when it is accepted, noting that actual trust will depend upon the nature of the grouping (e.g., a spouse will tend to have more trust than a next-door neighbor.)

The trust level may also consider shared interest groups. Note that shared interest groups will likely have cross-over with one or more standard high level group descriptors (e.g., Family, Friend, Business and Neighbor groups).

Table B (FIG. 6) shows one example of relationship group descriptors and associated quantitative and qualitative trust levels. High level group descriptors 630 set the column from which low level group descriptors are selected. For example, under the Business high level descriptor column, a user would be presented with the choice of low-level descriptors ranging from Supervisor to Competitor. The software seeks to build the trust in several relationships, primarily between the app and the user, between allies and also between participants in the private and public marketplaces. Table B (FIG. 6) describes a method of quantifying trust levels between two allies (or potential allies). The app may present a list of qualitative trust levels 620 associated with the high-level group descriptors 630 such as Family, Friend, Business, Neighbor or Shared Interest Group. The default high level group descriptor may be a friend, for example. The app reads the qualitative trust level that the user selects and looks up the associated quantitative trust level 610 from the table.

Table C (FIG. 7) shows one example of privacy levels that a user may select. Users may select their qualitative privacy level 710 from the above or a similar list of subjective level names, sorted in either ascending or descending order. A user may apply this privacy level to all sharing decisions made by the app or as a default privacy level. If it is used as a default, the user will be able to override the default for any groups (high level or lower-level sub-groups). The qualitative privacy level list may be varied by high level group descriptor or even individual sub-groups or shared interest groups, as is described above for naming levels of trust.

Each privacy level may have its own default behavior, with the ability for the user to override this behavior by either changing privacy or trust levels, or by customizing the behavior associated with their selected privacy level. For example, a user may choose Discreet as a default privacy level and then change the privacy level associated with neighbors to secret. The privacy level dictates how much profile information a user is willing to share. Privacy, trust level and shared interests are used, in combination, to determine what information is shared for each specific relationship.

In another example, the “Top Secret” setting would typically be used for those who are famous or concerned about revealing any information to anyone in their social fabric, for fear of being targeted. This setting would preclude allies from being able to see most profile information about the user. The “Top Secret” user may also choose a discoverability setting of “Invisible.” A famous person may still choose to be, for example, guarded to family, so the app may make it possible to specify different privacy levels for each high-level group (Family, Friends, Business, Neighbor and SharedInterestGroup) or the more specific low-level groups or relationship types.

### Generalized Use of Trust, Privacy, Discoverability, High Level Group, Low Level Group, Focus Level, Time-box Intention, Availability

Although each relationship (also known as an alliance) is unique, they may be managed in a generalized way by making use of the quantified levels of each of these relationship attributes associated with either the app user or their respective ally. Decisions regarding information sharing and interruptability at every stage of a relationship, ranging from discovery to established alliance, may be made with each of these settings available to the user's software. Most settings will rarely change, but some, such as Focus Level, Time-box Intention, and Availability may be dynamic, changing throughout a user's day. So, for example, when a user's Time-box Intention is set to “work”, those business allies with sufficient trust level may be able to see their availability and further be able to send them a synchronous message. Those with lower trust level might not be able to see their availability and their message might be queued for a time-box when the user indicates they would like to read their work messages.

### (7) Trust Levels Across Multiple Relationships

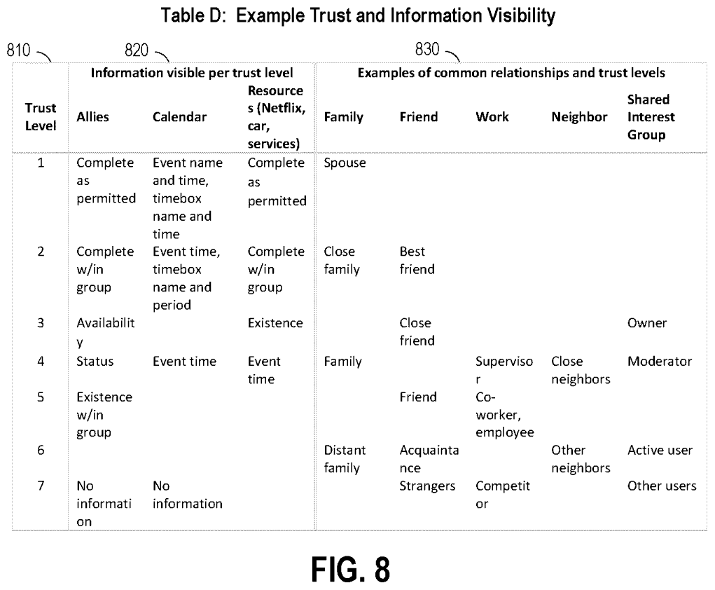

Table D (FIG. 8) shows an example of trust levels 810 and associated visible information 820 across multiple relationship types 830. The trust level for resource scheduling can be flexible and it also may be specific to a type of shared resource, where one or more “owners” of that resource have the highest level of control for it, and therefore visibility into all of its aspects, but the typical user may only be able to see if it is available or not. Note that the list of relationship descriptors need not be as long as the maximum trust level (i.e., it may be a sparse list).

### (8) Relationship Descriptor Lists (Partial/Example)

A descriptor is qualitative, by nature, such that a relationship descriptor is a qualitative description of a relationship. Users may assign relationship descriptors to each of their allies. These descriptors may have a high-level descriptor (e.g., Friends, Family, Neighbors, Business and Shared Interest) and a low-level description (e.g. Mentor, Spouse, Near, Supervisor, Tennis). The example multi-layered list below, allows users to assign relationship descriptors to each of their allies as they are added. In many cases, there are reciprocal relationships, so only the proposer of the relationship need specify it, and the proposal recipient is free to simply approve it. In other cases, the specific nature of the relationship assigned by the inviter may be kept hidden from the invitee, so as to maintain the inviter's privacy, but the general relationship descriptor would be provided. For example, the trust level for a friend is inferred from their relationship descriptor. A user might wish to invite a new acquaintance to become an ally. The user might describe this new friend as a friend/acquaintance by selecting the friend/acquaintance relationship descriptor. Their default quantitative trust level would be 5 according to the table below and when the relationship is proposed to them, they would only see that they were a friend, not the low-level description of acquaintance. The trust level may be changed on either side of the relationship at any time. Over time, the app may suggest a trust upgrade for an ally with whom the user exchanges many messages or spends a lot of collaborative time. The app may also confirm the trust level assigned to each ally at some point. This may be done by describing all trust levels in quantitative terms.

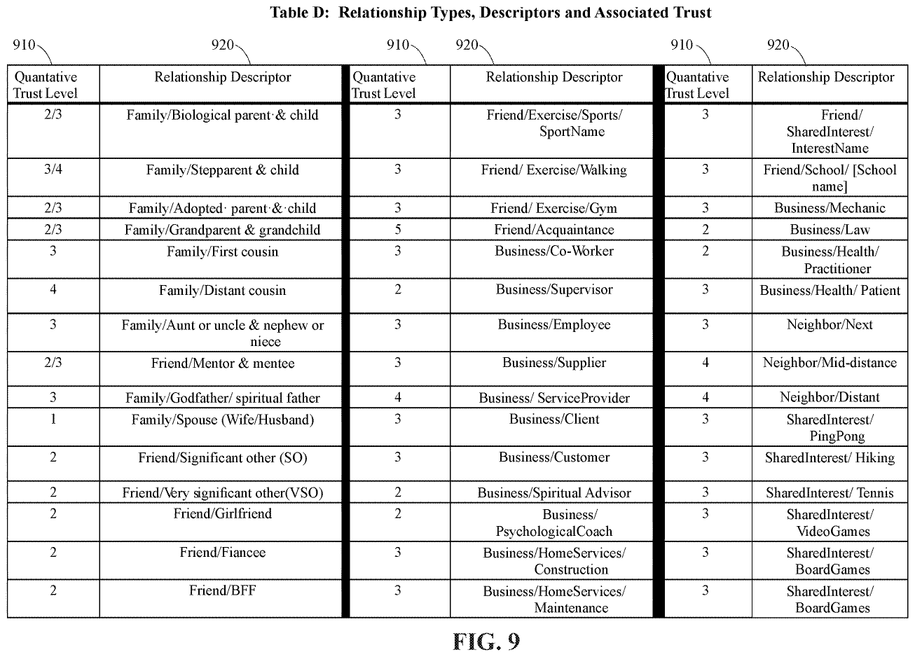

In some cases, an ally may have more than one type of relationship with a user. For this reason, multiple relationship descriptors may be selected. Table E (FIG. 9) shows examples of Relationship Descriptors 920 associated with Quantitative Trust Levels 910; particularly Table 4 (FIG. 9) shows an example of Relationship Types, Descriptors and Associated Trust Levels.

The example shown in Table E (FIG. 9) may form a standard list of relationship descriptors, and users may be allowed to add subcategories, such that the app may add popular relationship types to the standard categories as the need arises. Table E also shows a clearer association with trust levels for each relationship descriptor.

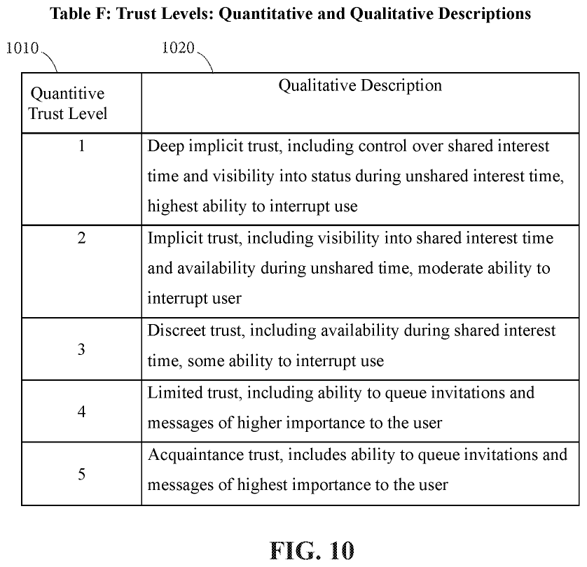

Table F (FIG. 10) is an example of Trust Levels: Quantitative and Qualitative Descriptions; particularly Table F shows qualitative descriptions 1020 of quantified trust levels 1010.

Note that the descriptions in the tables are only example guidelines for the software. If the user finds that the app is too permissive in certain cases specific to one or more allies, they may reduce the trust level for said one or more allies. However, if the user finds that the app is too permissive across the board or within a high-level grouping, they may choose to adjust their privacy levels to indicate less openness to interruption and visibility into their profile is desirable. They may also adjust their own discoverability.

### Shared Interest Groups and Descriptors

Note that shared interest groups and their descriptors may be high level or lower level. The high-level descriptors for the groups may be fixed, for example: friends, family, neighbors, and business. All other groups might be sub-groups of these high-level groups, or they may reflect other shared interests that do not fit these standard high level descriptor categories. The app may allow each user to manage their own high-level groups and also create or join shared interest groups. Subgroups may have user-assigned names and group owners.

### (9) Social Fabric Diagram

FIG. 11 shows one embodiment of a social fabric diagram, 1100 also called an “ally diagram” which may be utilized to represent the ally relationships of a user. Particularly, the social fabric diagram may display all or part of a user's social network or ally list. This diagram displays the user's relationships on a series of concentric circles 1110, representing intimacy circles, which can be very useful for relationship management, and understanding the user's ally relationships. The social fabric diagram also includes a Venn diagram (ellipses, for example as we represent them in this diagram) to denote shared interest groups and allies, which are placed in the intersection of their associated intimacy circle (according to their trust level) and the shared interest group. In this example the Venn diagram sections (shown as ellipses) include a Friends section 1120. a Business section 1122, a Neighbors section 1124, and a Family section 1126. In alternative embodiments the information on the social fabric diagram may also be displayed using a list and the app may provide the user the ability to select between a list view and the graphic social fabric diagram view. The app may also provide the user the ability to filter allies (not shown) according to groups, intimacy levels or any number of other means to reduce the number displayed, for example: availability, most recent activity, upcoming collaborations, and so forth.

Collaborations may be formed with a single ally, an ad hoc group of allies or with named groups. These collaborations may be added to the user's GetToDo list and have prompts assigned to them, either automatically according to a user-selected policy, manually (user-selected per collaboration), or with the help of the app asking the user how they want to be prompted. These types of GetToDo entries may also be kept in a collaboration list, such that they may become part of a historical list of collaborations forming the collaboration layer of the calendar portion of the app. Collaborations may also be known as get-togethers for personal time or among family, friends and neighbors; and meetings during business hours or among business allies

In the example of a social fabric diagram 1100 shown in FIG. 11, the title 1104 of the screen includes the user's first name. A purse 1108 may be available for keeping track of halos and/or cash-on-hand, similar to Venmo or other on-line coin purses. In some embodiments to make better use of available screen space, the ally's name may be shortened from their full name to a short name, or reduced down to a small icon or even just a group of pixels. Pinch to zoom (or similar method) may be used to zoom in and out.

In some embodiments names or icons indicating ally entries on the social fabric diagram 1100 can be color-coded, for example the following color codes may be used: Grey: name and ally contact information entered, and invitation sent; Red: ally is in relationship, but not available; Orange: ally is in relationship, and available only in case of emergency; Yellow: ally is in relationship, and available for a price; and Green: ally is in relationship and is freely available.

Creating a User Profile from the Perspective of a Social Fabric Diagram

A social fabric diagram can be useful in creating a profile. Using basic functions of the diagram, each user can fill out their own social fabric diagram and use it, going forward, as a sophisticated ally list, with a few nice properties:
1. The most important ally is a user's own profile. They generally would need only to enter enough information to uniquely identify any allies they wanted to add, which would generally be available in an imported ally list or simply by looking at each ally in their phone book or address book, in turn. From the user's profile window, then, an invitation can be sent to an event or to join and establish an intentionally managed relationship can readily be generated. Once in an intentional relationship, each side may choose to “import allies” from each other, as appropriate. In some embodiments importing allies from each other may be a primary means for growing one's network. However, allies may also be imported from various other standardized sources like vCards.
2. It is the responsibility of each user to fill out their own profile and specify its privacy settings.
3. Contact information may be added or imported but not edited once the contact becomes an ally. Each user will generally only have control over their own profile, and that profile will be associated with their globally unique user ID, assigned when they become a member. If a user's info changes (they move or get a new phone number/email address or they simply change any aspect of their profile), that user will update their own information, which will either push updates to their allies or make them available upon request, replacing the outdated contact information for the allies to view automatically.
4. Contact/profile info is held in an object, whose members and methods may change over time. Each person's profile typically includes the globally unique user IDs, trust levels and shared interests of their allies.

The app will display or withhold a user's personal information subject to privacy/trust levels set by all relevant users. Each user may dictate whether, and to what extent, their own information is shared to various categories of other users (allies, allies' allies, strangers, etc.). The service will, then, only show information between/among users when all trust/privacy settings accommodate such sharing.

In some embodiments the app running on a local user's Mac or PC may provide services to all allies. This service will keep an encrypted/protected mirror of one or more allied user profiles. Changes to individual profiles will be pushed to all allied services through appropriate store-and-forward channels to keep them up to date. These changes may only be made by the individual profile owner.
5. Trust Level: In the Social Fabric Diagram, the level of trust may be indicated by the radius of the circle in the above diagram. Also, the level of trust can be kept as a floating-point number internally, to allow for slow automated change to trust levels or to provide manual user adjustment. Automated trust level changes could increase trust for oft-used allies and decrease for rare use or based on other factors like user-indicated quality of experiences, duration of relationship, or others. A user could enter and store such quality-of-experience data by swiping directionally. The main social fabric diagram may be flattened to one dimension and made scrollable if it becomes too cluttered. It should be simple to select friends, family, neighbors, and business allies, and perhaps drill down to lower levels, as well (a specific shared interest group . . . only 1^{st} or 2^{nd} degree relatives, only nearby neighbors, etc.).
6. Allies may be invited to a chat, event or meeting through the social fabric diagram starting using the Collaborations and Scheduling features. In some embodiments, clicking or lingering on an ally icon/name will bring up a view of their availability and allow the user to continue in setting up a single or recurring collaboration. Also, a messaging and meeting history may be available from this ally window.
7. A persistent chat session may be set up with allies who also use the app (single allies or groups).

User availability is a useful concept here and is particularly useful for Collaborations and Scheduling and achieving Personal Intentions. It makes the above social fabric diagram into something of a “marauder's map.” There is a concept of co-work, to facilitate mutually agreed focus on whatever tasks there are at hand. So, allies and their statuses could be readily used during focused work periods. In an embodiment in which the user's calendar information is shared, a color bar or similar display mechanism may be implemented indicating each ally's near-term availability, personalized to this one unique relationship.

A user may be allowed to set a certain privacy level, which may be used for one or more forms of sharing within the software. The privacy level may be enumerated, for example:
Private=1: ally only through the app and don't share any allies, new allies by mutual agreement only.
Careful=2: share external address information with 1st degree allies and allow them to see current and future status, erring on the side of caution.
Discreet=3: be smart about both sharing user's own ally and calendar information and that of their allies.
Apathetic=4: handle it how it best makes sense and err on the side of openness.
Open=5: For the salesperson, few or no restrictions.

The privacy level may be automatically adjusted as the users' number of collaborations and/or allies increases, or in concert with their stated level of “busyness” or “overwhelm”. Once a user has stated a certain privacy level, either temporarily or for a long term, this stated intention may be honored by, for example, limiting ally searches and discoverability or reducing (or increasing) the openness to collaboration suggestions from others. For this reason, privacy levels and levels of discoverability, as described below, may initially have integer levels upon first assignment but they may be expressed as decimal representations as they are adjusted.

### Communication Representations in the Social Fabric Diagram.

Conceptually, the four ellipses in the Social Fabric Diagram may relate to past communication aids that are no longer fully working in present day society:
1. In the past, neighbors could be found in the white pages, including their physical addresses. Now, even cellular phone numbers are not generally listed and are subject to spamming. The neighbor-to-neighbor communication ellipse is representative of the “white pages” in the telephone directory (Searchability is key here.)
2. Similarly, the business ellipse is analogous to the consumer-to-business communication in the yellow pages of the telephone directories. Currently the yellow pages are a) expensive and b) limited to formal businesses. We want everyone to have at least one yellow page entry, if not many more. (Searchability is key here).
3. The family section can be represented by a family tree, akin to the recent upsurge in genealogy, where people are re-connecting to their roots. In one embodiment, there may be links to genealogy resources or, in other embodiments a family tree may be displayed. If relationships are entered properly such a diagram would not require extra information from each user and may help for more distant relatives to be able to contact each other, subject to privacy and trust concerns. For example, if a user marks themselves as private or undiscoverable to family members, they would not appear on the diagram, or if they did, their contact information may not be available. In another example, if users list themselves as open to family members, distant cousins may be able to contact them more readily than having to go through intermediaries. Family tree diagrams may contain links to video interviews for individuals on the tree or specific relationships, such as couples, parent/child, cousins, etc. This information may be stored and streamed from each individual user's device or from the cloud. Users may choose which device holds the video information. They may also provide a link to a cloud resource, such as youTube, oneDrive, AWS, etc. where the file is held. The app may support the genealogical interchange file format (GEDCOM) for importing and exporting family tree information, where each user may decide how much of the tree to export and how much of each user's profile to export, subject to privacy and trust limitations within the family. Likewise, the user may be able to input a GEDCOM file and provide tools for merging entries in the file with allies in their family social fabric.

The friends section, which may be in the nature of Facebook, LinkedIn, or similar groups, is created when a shared interest is in play. Here, group membership, moderation, and so forth, may be factors, with certain users given moderation responsibility and associated rights.

### Information Sharing: Sharing Decisions

The basic user settings for privacy and relationship allow the app to make default sharing decisions. These sharing decisions may be displayed to the user for their confirmation and adjustment. These default algorithms may make use of both the qualitative and quantitative (i.e. enumerated or ordinal) values selected for privacy and trust. The app may allow the user to associated trust levels with one or more of their groups or individually with each ally.

Sharing decisions may use a scoring system or look-up table to decide who is trusted with various types of information, such as: contact information, schedule availability, time-box intention (work, personal, vacation, etc.), collaborators, commitments, intentions, shared interest groups, time-box templates, allies, user offers and profile information, where profile information may include a variety of favorites, such as restaurants, grocery stores, movies, books, TV shows, hikes, sports, board games, video games, etc. These decisions would be based upon trust, privacy and shared interests (high- or low-level group).

### (10) Communication

### Software Messages

The terms “software messages”, “messages” or “chat messages” may be used interchangeably to indicate a message which is sent between two allies or between a user and the owner of a marketplace listing. A history of these messages may be available in the context of the ally or marketplace listing.

### Group Chat

Group chat among shared interest groups or subsets thereof may be set up by selecting each user of interest or by designating an entire shared interest group for messaging. The group chat would be visible when selecting the label for the group. In the case of a group subset, a new label and Venn group would be added to the diagram and said group would be added to the selection capability for Venn groups, as a subgroup of the original high level group. The group chat may support features akin to chatroulette, a popular web app that allows users to jump form chat session to session as they desire. However, the app is likely to discourage chats with strangers in favor of chats with those in the user's social fabric with the greatest trust and shared interests. The app may provide Smart groups (starting with an inner circle and working out to strangers with a threshold level of shared interest). It may provide group creation and management tools, inviting available allies to join a group. Allies may be auto-included if they meet a certain trust level and/or shared interest threshold.

The app may provide a quick exit for users who don't want to be a part of a given group, for example simply swiping downward.

The app may provide for group “president” and admin elections scheduled and carried out if elections are moved and seconded by two present group members or if election is proposed by current group owner, for example. The present group owner and admins will have a certain amount of control over the election, as appropriate.

New owner and admin status may be limited to those who have volunteered as a technical support resource to their closest allies.

Each group may have a flexible set of group rules, set by group owner/admin, and citable any time there is a problem. There may be a base set of rules or suggested rules established by the software to encourage positive interaction.

Group chats may have decaying or throttled notifications by size of group or rate of receiving messages. For example, the first message in a certain time frame may elicit an audible tone if the user is in an unfocused time and the chat message is within the time-box context of interests the allies share. For example, if a group chat among business allies is received during a time the user desires to be doing focused work or to be with friends and family, they may not be notified the message was received. The presence of the message may then be queued and noted at a time when the user has set aside to read messages.

### Business Accounts

Business accounts, and their associated yellow page listings, may be created and associated with a business owner or assigned administrator, such that messages do not go directly to or from the business but rather to/from their designated representative. The officers of a company may be set up to have shared administrative control over their business listing, and they would also form a business-related special interest group. All employees may be able to join in an employee-specific chat, with necessary limits for large companies to encourage high quality content and constructive interaction. Business accounts may allow for booking time or paying for services. They may link to a company web page. They may link to support resources, reviews or references. They may also link to one or more employees, as desired. for example, these links may include a PR link, investor relations, tech support, feedback, or to a specific role within the company, such as HR, treasurer, CTO, CEO, etc. The business account may be used to schedule work meetings or collaborations with members of allied companies or to share resources either within the company, such as meeting rooms, or outside of the company, such as van pooling or other company-sponsored functions that might be opened to those outside of the company. The business account may provide an automated org chart for internal and/or external purposes, again within the limits of privacy and trust relationships. The app may have a built-in business account for users to communicate with its designers, developers, content creators or officers. It may build in accounts for other trusted service providers, as well.

### Communication Limits: “Focus Level”/Interruptability (Availability)

A user may indicate availability for interruptions in a number of ways:
Availability of the user is usually indicated by creating/editing a time-box. The category of time-box or time-box intention may be associated with default values for interrupt-ability.
Synchronous (ex: phone calls)
Asynchronous (ex: notifications)

A user's openness to interruptions, or availability for notifications, may not be “all-or-nothing.” Depending on the context, a user may be open to certain interruptions, but not others. The software models availability to an interrupt based on a variety of factors, including said user's current context (focus level, time-box intention, current collaborators, availability), the identity and associated trust level of the ally trying to interrupt said user, the mechanism of the potential interruption (text vs. phone call, haptics, etc.) and the ability and/or desire to pay. The app will thus allow said user to employ a dynamic status, filtering out all unwanted interruptions, and it may provide a mechanism for the interrupter to pay the interruptee for their trouble, either in hard currency, the rewards currency of the application or any form of cryptocurrency. In one embodiment, the app may allow the user to charge a higher rate per unit of time in the first small unit of time (e.g. a minute) due to interrupt impact. The app may also allow the user to charge different rates for different specific relationships, high level relationship types, low level relationship types or trust levels.

### Notifications

An “importance score” may be assigned to each notification that a user chooses to request for themselves, and the strategy of the notification may be modified accordingly. The importance score may be based upon prior stated or calculated importance of a given commitment, present user focus level, present collaborators, the cost of missing or being late for a commitment and the nature of the relationship with collaborators associated with the commitment for which the notification is being delivered. The cost of being late or missing may be modeled from such statistical likelihoods of receiving a bad review, being fined, disappointing allies, missing work deadlines, negatively impacting allies, or other forms of damage to a user's reputation or finances. It might be rated on a sliding scale from, for example, highly flexible to mission critical.

Regarding allies, the visibility of Allies for discovery may be limited by Social Circle (shared interest group) and their discoverability setting. Visibility of an Ally's information may be limited by Level of Trust, Social Circle and their privacy settings.

### Inter-Alliance Messaging

Within the context of an alliance (an intentional relationship between two or more users), messages between said users may be transmitted in some embodiments either from a user profile or group page or from the home screen. The sender of the message may indicate a sense of urgency, either by indicating a required timeliness or other subjective scale (emergency down to casual conversation). The default sense of urgency may be set to the lowest level, such that the sender must change it manually to indicate a greater sense of urgency. Once a message is sent, if the message is not received in a timely manner (according to their sense of urgency), the sender may increase its sense of urgency.

On the receiving end, the recipient will have a current level of focus such that, for example during focused work, only emergency messages or those from trusted allies might evoke a notification and inherent distraction for the receiver. Similar to other cost function mechanisms of the software, a scoring mechanism may be used to determine when best to inform the recipient that a message has been received, when to encourage them to read it, and when to respond to it. If a message does not meet these notification requirements initially, it may be queued for later notification, reading and response at a more appropriate time. A user may indicate a preference for reviewing messages at a certain pre-designated time of day and decide when to respond to them if they are not of an emergency nature. The messages may be sorted in order of urgency, such that only the most urgent ones are presented first.

Both parties will have the ability to rate a given conversation. Each may rate the urgency of their own messages, and they may also rate the accuracy of the sender's perceived urgency. If a sender's urgency is rated as inaccurate, the receiver may choose to downgrade their trust in that user or their ability to interrupt them during focused work periods, for example. This downgrade may have a certain temporal nature, allowing for an ally to have a “bad day”, rather than expecting them to always be untrustworthy because of a single difficult conversation, and thus the downgrade may have a degrading effect over time, until such time that another downgrade comes into place. The receiving user may be prompted to decide how long this downgrade is in effect (e.g., an hour, a day, a week, a month, permanent, etc.). Similarly, each user message recipient will have an opportunity to rate the quality of the message.

The level of importance of a message may have several gradations, for example: Dire emergency, Extraordinary, Ordinary, Entertaining, Informational, Message quality may have several gradations, as well, for example: Truly inspiring and life changing, Professional, Clear, Biased, Deceitful, or Nonsensical.

A timeliness may also be assigned to a message. Messages may have a default timeliness assigned, associated with their importance, with the sender able to modify the default. Timeliness may, for example, have several gradations: 1) Urgent, please read ASAP, 2) Important, please read at soonest convenience, 3) Normal, please read within a day or so, 4) Unimportant, please read within a week or so, or 5) FYI, read at your leisure.

Upon sending a message, the sender will receive confirmation that it is sent once it makes it to a store-and-forward server, whether that server is on the recipient's device, in the cloud, or in a mutual ally's device. The recipient may send and the sender may also receive confirmation when the message is read and when it is responded to, including a date and time stamp. Further, the recipient may send, and the sender may receive scheduling information, for when the recipient plans to read or respond to the message. The sender's device may notify the sender of each of these types of information in a number of ways, including changing colors of the message in the sender's message history, providing an iconic representation or animation of the message status, and making this icon responsive to display message status information, including a list of status changes and associated times of those status changes. Typically, times are displayed in time zone local to the user.

There may be multiple quality rating systems, as well, for different measures, such as for professionalism, informativeness, relevance, etc., each with its own similar scale. The sender may optionally rank these, and the recipient may review the sender's rankings and modify them. The recipient may also rank the quality or tendencies of the sender's ranking system. These tendencies may be expressed by a level of realism: Maximizing, Exaggerated, Realistic, Downplayed, Minimizing, and so forth.

These distinctions may be used to modify a recipient's planned actions regarding future messages received by the sender, either increasing, decreasing or keeping the same ratings the sender applied to future messages. For example, if a recipient rated a sender's message as “maximizing”, the next message received may be downgraded by one or more levels in importance and one or more levels in timeliness. Statistics may be kept for these ratings, to temper expectations for the sender of each message. The app may also provide tips and rewards to improve writing skills, increasing quality ratings for those who participate in trainings and for those who demonstrate such skills. The rewards may be in the form of a special badge or status, increased visibility of their messages, or increased quality ratings for their messages. Quality ratings may be either automated, or crowd sourced according to the readers of the messages.

These rating systems may vary depending upon the stated purpose of the message. Simple messages with basic information may need nothing more than a rating that says the message was received and understood.

The app may display these ratings, use them to guide underlying software behavior, or both. The app may use these ratings to identify likely bots and remove them from the system. The app may add a mechanism to report suspected bots to a centralized server and the centralized server may have the ability to flag a member account as a suspected bot, keeping a log of suspicious activity and using that log to automatically or manually act to suspend and/or remove said bot's account, as well as potentially blocking contact information associated with said account.

### Prompts and Prompt Strategies

A user's profile may include a list of one or more prompts. Prompts are a combination of a notification and associated information regarding the reason for the notification. A prompt may be specified as “requiring acknowledgement”, in which case a means for acknowledging the prompt will allow the user to dismiss the prompt and let the app know that they have received it. A number of named prompt strategies may be made available to the user for application to their time-boxes, calendar commitments or other time-sensitive GetToDo items.

For example, a “Red Alert” prompt may play an audible notification intended to get the user's attention and it may require acknowledgement. If an acknowledgement is not received, the volume of the audible notification may be increased and re-played or a different prompt mechanism may be used, such as alerting a different device, sending a text message, making a phone call, or alerting those allies involved in the commitment that the user is not responsive to the prompts. Prompt strategy names may be standardized, user-selectable or both. Likewise, strategies may be pre-canned, user-designed, or both. Notification sounds may be similarly pre-canned, selectable, or added by the user. The information conveyed with each prompt may be automatically formatted by the app from information regarding the reason for the prompt or set by the user. The formatting may include an indication of the amount of time until the commitment starts, its title, collaborators, importance, etc. The user receiving the prompt may choose to upgrade or downgrade the importance of the prompt with an upward or downward swipe direction. In such case, the prompt strategy may be adjusted. For this reason, the prompt strategies may be listed in order of urgency.

### (11) Collaborations and Scheduling

The Collaborations and Scheduling module is intended to be a smarter version of present calendar systems. This will only address layer three of what is envisioned as a five-layer calendar, and yet it is intended to be more powerful than any of the major calendar systems like those of Apple, Google, and Microsoft (Outlook). However, the Collaborations and Scheduling module may be implemented in cooperation with a third-party calendar system, or developed from scratch, or somewhere in the middle, perhaps making use of an exchange server, for example.

An important objective of the Collaborations and Scheduling module is to make it easier for users to schedule time together when they are not already on a common calendar system like Outlook/Exchange. In a sense, it is a more like a sophisticated version of DoodlePoll and a free version of something like SuperPeer or Calendly.

When in a collaboration, the app may make it possible for the user to swipe up to “raise their hand” to form a bookmark for the conversation. This might open a window to allow the user to type in what they wanted to say, such that the user may then get back to listening in the present conversation. The presence of the bookmark and the text the user entered may be shared with others in the collaboration. This mechanism may be used if a user would like to interject for any reason, such as if one participant is monopolizing the conversation, the user needs to leave soon, or they simply have a question.

Also, when in a collaboration, the app may provide a mechanism for the user to: set to self-grade their listening, asking questions like, “How interested in this collaboration am I?” The app may allow the user to indicate their own level of engagement by, for example, swiping upward when excited. The app may keep track of the interest level and display the state of the model over time, letting it decay as the collaboration continues without a positive indication of excitement form the user.

Although the interest level of each user would be private, the app may note when mutual interest level in a synchronous conversation decays too far, with a music or tone getting louder and louder or notification that conversation will end soon, so wrap up, or the app may adjust a visible count-down timer.

In the event of an asynchronous text, video and/or audio chat: the app may infer from how quickly or how often collaborators respond whether it might be made into a synchronous chat, providing all parties are available and amenable.

The app may allow recipients of such asynchronous messages to adjust playback speed, and infer interest from this speed. That is, if a recipient speeds through or skips ahead, it would be taken as a sign of less interest.

### Collaboration Templates

Collaborations may be thought of as contracts or commitment devices.

Below are example booking pages for an example listing, where anyone can book time with an ally. An ally may book time with John Doe for a price set by the user. A listing template might include: 1) Hourly rate, 2) Importance, 3) Collaboration Type, 4) Flexibility/rigidity, 5) Late and/or no-show fees, 6) Start and End Times, and/or 7) Policies.

Policies would dictate a set of preferences for how a schedule is filled out: maximize revenue, maximize tight time-boxes (play sardines with time commitments within each box), incentivize sardines (discount for booking adjacent time slot) or penalize/prohibit booking non-adjacent times. Here, airline ticket booking models might be useful. Charge less with greater advance notice and charge more for short notice. Note that the ability to collaborate with a particular ally might be available through their ally pop-up window (available from the social fabric diagram.) or via a number of different locations, depending upon the shared interest. Any collaboration that included compensation would generally be booked through the ally's associated yellow page listing or through their help-wanted listing.

Collaborations may also be booked through selecting one or more allies on the social fabric diagram or through a group page. Once the allies are identified, the joint availability or individual availabilities of each ally may be displayed. The availability may show the first and subsequent times that provide a suitable fit or it might rate the goodness of fit based upon a scoring algorithm, displaying the top matches first. An invitation to collaborate may be sent with or without a specific time, said message indicating an interest in collaborating and providing a range of potential mutually agreeable times. This process may be used regardless of the interests the allies share, but it may be focused on certain appropriate times according to their mutual interest. For example, a family collaboration would not generally be scheduled during any of the family members' work hours. Likewise, a business meeting would not likely be scheduled on a user's day off, unless the nature of the relationship specified that it was a meeting between a private person on their personal time and a working person on their work time.

Availability scores for each individual user and collectively may be scaled by a user's intended focus level. A user may define a focused work time, such that they do not want to attend work meetings during this time, in general. However, if the time is the best time for others to meet, they may indicate a degree of flexibility in the use of their focused work hours.

Collaborations may also be organized around one or more user's offers or needs. These “advertised” user desires would have their own tie in to the user's calendar, with bounds for the hours during which they are available, if the offer or need requires a collaboration effort. The collaboration effort may be as simple as a short meeting to look at a product and agree on a price, or it may be a time during which a service may be provided. And finally, it might simply be a time during which two allies can jointly pursue a mutual interest, such as a sport, a game, a club, a hobby, etc.

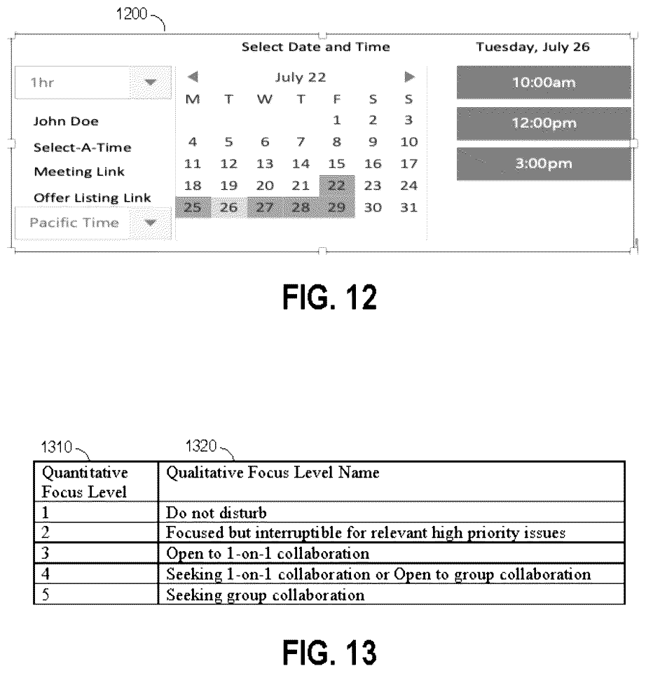

FIG. 12 is an example booking form 1200. Multiple methods may be provided for users to set up collaborations, depending upon the type of collaboration:
1. Manual/focused:
   a. Suggest one or more times
   b. Have the app suggest the best time(s)
2. Search:
   a. Neighbors and business: collaboration type, geographical, hourly rate, availability (assume someone is legit, so do not allow searches on reviews, but display review scores when applicable).
   b. Friends: collaboration type, geographical, availability, trust level
   c. Family: collaboration type, geographical, availability, trust level.

In one version of the calendar, users may define when they are available to certain types of friends, family members, business contacts and neighbors during the course of the day, and if they should be marked as available or busy during times that they have a pre-existing commitment.

### (12) Calendars and Calendar Layers

### 1. JM Note: Review the Following Carefully

Improving on a single-layered calendar, a richer set of intentions is described around how we spend our time. The system provides layers that allow the user to define intentions for how the user spends their time, not just a list of sporadic commitments, as most people use their calendars.

### Layer 1 Calendar

The first, and a foundational layer of intention is a user-settable mission statement or statement of intentions. For example, it might be something as simple as, “show up in the world with loving kindness.” It might also include habits that the user wishes to make and habits they wish to break.

### Layer 2 Time-Box Intentions

From the first layer, we can build a second layer of time-box intentions, based upon how each member would like to spend their time. This second layer of the calendar is meant to cover the user's intentions continuously (24 hours/day), starting with a simple distinction of work, personal and sleep time and then adding lower-level categories of ways that they choose to spend their time. A time-box calendar may only cover a portion of the user's day in detail, as desired by the user. The second layer forms the foundation of a display and contains the time-boxes used to hold the user's context 24 hours/day. The user's context, then, is any details that go into a single time-box. On a day plan screen, the next 24 hours, including the present time-box, is displayed in list or pictorial form. The home screen takes its contextual information from the current time-box, including focus level, collaborators, GetToDos, notes (personal and/or shared) and time window information. Subsequent layers, then, are associated with one or more time-boxes of layer 2 and also available on the home screen when they are applicable, to keep the user oriented in time and intention. In pictorial form, each time-box may be arranged in a row, to form a long column or row, or they may be shown as a pie chart, with each slice the fraction of each 24-hour day the user intends to spend in that context. It may also be displayed in scrollable list form. The app may provide a means for the user to select between a plurality of such display modes, allowing the user to select a particular time-box to see its contents in more detail and edit it, as appropriate. When edits are made, the app may ask the user if they are for just one time, for all days of the day type associated with the time-box at-hand, or for all future days, in general.

Time-box intentions might be sleep, personal or work intentions, with more than one level, like a typical branching tree structure, such that the high-level intention descriptors may be used on some displays and more detail on others. For example, the high-level descriptor for sleep may have two low-level descriptors associated with it, called “Night” and “Nap”. The high-level descriptor for work may have intermediate level descriptors named “Focused” and “Unfocused” and under those, the types of focused and unfocused work a user might do would fall

There might be a level of rigidity for each of these intentions, both personally and contractually with others, with a flow-through of rigidity, such that impacts to schedules of others are minimized while still maintaining individual goals. Rigidity may flow into a cost function for arriving late or missing a commitment altogether. Comitments are associated with layer 3. This cost function serves as an estimate of the importance of showing up on time, and helps the software to understand what efforts are appropriate to get the user's attention with a notification and provide them the contextual information that turns the notification into a prompt. Each of these layer 2 and 3 intentions may also carry with it a set of instructions for how interruptible the user is and with whom they may want to share time during their respective time spans. See the next section regarding collaboration templates, for how these collaborations would be set up.

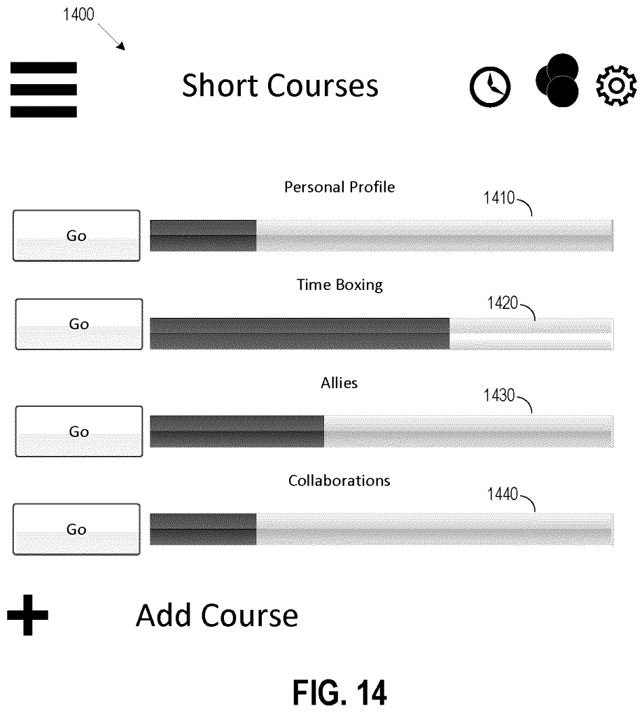

Table G (FIG. 13) shows an example of mapping between Quantitative Focus Levels 1310 and Qualitative Focus Levels 1320. Focus levels are useful; In addition to rigidity as a layer 2 or 3 time-box attribute, there is also focus level. Focus level provides a guideline for when a user is open to collaboration and when they are more focused on a specific task and therefore wish to minimize interruptions or work with others. Focus, then, might be enumerated according to Table G, or a similar one.

Weather-dependent reminders/alerts may be scripted, responsive to forecast conditions. For example, when raining cover patio furniture and turn off sprinklers, when too cold turn on heaters, when snow is forecast make time for shoveling, when high temperatures, remind to wear shorts and drink water, when low, remind to wear hat and gloves. These alerts may be generated in cooperation with one or more weather apps on user devices or by the app directly requesting weather data from a network service appropriate to the phone's current or planned location. These weather-dependent reminders and alerts may interact with other apps for smart homes and the internet of things through standardized interfaces.

Collaboration is defined as any event, meeting, get-together, gathering or time when the user is in intentional communication with one or more allies, either in person or via telecommunications such as the internet VOIP, phone call, video call, social media, or simply experiencing the same form of entertainment contemporaneously. The software standardizes on naming personal collaborations either get-togethers or gatherings and work collaborations meetings. It may also allow the user to choose from two or more of the above names for collaborations, with the understanding that they will be treated the same in the underlying software functionality.

### Layer 3 Collaborations

The Collaborations and Scheduling module deals with this layer, which is meeting commitments/interactions. On this layer, we may want to have tools for finding people with like interests, for example, examining their first and second layer, while also having access to the third layer.

### Meeting Set-Up and Facilitation

Micro-meetings may be set up on layer three, when a user indicates that they are open to them on their layer 2 calendar. These micro-meetings are intended to be time limited. A notification of interest in micro-meeting may carry a different notification tone, haptic indication, or text/visual display than a typical interrupt notification depending upon the desired conversation duration, sense of importance, topic area, rigidity, or importance of duration intention. In this regard, a micro-meeting may be a smart voice and/or video call. The notification of interest, analogous to the ringing of a phone, might carry a user-selected sound and provide other salient information such as the desired reason for the micro-meeting and the desired duration, as well as the identity of the caller. A micro-meeting invitation may not be presented to a user in real-time for the same reasons that a regular meeting or text message received from the user may be queued for later viewing, depending upon the receiving user's stated openness to interruption and their openness to micro-meetings during their present time-box. In the case that the invitation is not presented in real-time, the sender of the invitation may be notified that the recipient is busy, and their invitation has been queued. In such case, the setup of the micro-meeting would be treated like any other collaboration.

The sender of the invitation to a micro-meeting may be prompted by the app to specify one or more of the urgency, duration, topic, rigidity (or flexibility), importance or any number of other attributes about the proposed meeting and these attributes may be conveyed to the receiver. Both parties may be asked to review each other after the call on one or more basic measures. The review questions may be written such that a bot may find it difficult to automatically provide a positive review. For example, accuracy may be rated on a scale of understatement (minimizing) to overstatement (maximizing), where the highest rating would then be in the middle, or the order may be changed periodically or at somewhat random times. A bot's ratings might change statistically with this change in the order, and this might flag the respective account for review by the technical support mechanism of the app.

The duration may be enforced if one or more users determine that the length of time for the collaboration is sufficient and as the end draws near, notifications may issue warnings to one or more users, or the collaboration may automatically terminate.

An indication of availability and duration of availability and the underlying mechanisms required to automatically calculate this availability on an ally-by-ally or grouped basis may be displayed to one or more collaborators.

A notification of the end of the upcoming micro-meeting may be swiped according to the guidelines further described herein to indicate an acknowledgement of the notification and any changes to its rigidity. The rigidity may be set by default or by user-selection from a pre-determined list at the initiation of the micro-meeting. The rigidity displayed to two or more participants may indicate the combination of the two or more meeting participants' rigidity across one or more of each of their schedule layers. The default rigidity for the meeting may relate to the trust level that each collaborator has for allies in the group, or in a trust level indicated for the entire group. There may be a certain amount of default “time hysteresis” or “grace period” associated with each rigidity level. A count-down timer for the micro meeting may reflect the remaining time and may also reflect the associated hysteresis or a combination thereof.

The micro-meeting or any collaboration, for that matter, may continue for as long as there are at least two participants, or it may discontinue if the leader departs unless a new leader is nominated. It is important to note that a micro-meeting may use any communication medium or be in-person. The communication resource may be associated with the app, or it may be external to the app. Regardless, what is known about the meeting to the app may be entered in a log for the relationship.

### Layer 4 Location

A fourth layer is location: for example, where are the users doing these things, and how does the trajectory of their day best fit together? How does their planned trajectory map to their actual trajectory? Tasks which are performed on-line must be marked as such, but there are exceptions. For example, people can have conversations while walking and getting their exercise in, even if they are on opposite sides of the world.

The location layer tool will depict the planned trajectory of a user's day, including how much exercise they are likely to get. The goal is for built-in exercise. This feature would present a comparison of a user's planned trajectory and their actual trajectory, as well as prompt them to plan a more personally satisfying future trajectory and help them to put that plan into place.

### Layer 5 Communication Medium

A fifth layer is the communication medium (Video conference, asynchronous chat, phone call, e-mail, etc.). This allows the app to do an even better job of presenting the home screen for each user, appropriate to the communication medium. In general, the context will be shared on each user's home screen, some of which may be shared, such as shared notes.

### Layer 6 Meeting Space Resources

A sixth layer involves identifying and displaying available resources (or lack/need) for meeting space, whether physical or virtual. For example, if one ally has a paid zoom account or if the collaboration is set to take place in a public park with reserved picnic tables, library meeting room, commercial office space, restaurant requiring reservations, etc.

Meeting space resources may be linked to through the marketplace.

### Layer 7 Transportation Resources

A seventh layer involves identifying and displaying available resources (or lack/need) for transportation resources. Transportation resources may be linked to through the marketplace.

### Layer 8 User-Defined Limited Resources (Venue, Equipment, Etc.)

An eighth layer involves a user-assignable resource type. It may include anything that is shared, such as on-line “family” memberships, construction equipment, recreational equipment, etc. These resources may be made available “for hire” through the owners' yellow page listings and booked by others in this way, noting that each user's yellow page listings may be limited in their audience, according to each user's preference and the pricing is also user controlled. Booking of these resources, when they are offered in exchange for compensation, may prompt the need for a confirmation from the purchaser, to authorize payment, either one-time or periodic. Certain resources, for example those associated with a user's home, may only be available to their close family members and therefore be managed with a private marketplace listing, whereas others may be assigned to a public marketplace listing.

### (13) Prompts, Notifications, Classification, User Alert Method

In practice, notifications can be both a great help and a distraction, depending upon their desirability. We define a prompt as a combination of a notification (either visual, haptic or audible, or some combination thereof) and the information accompanying the notification, instructing the user to help them understand what the notification is for and any extra information they may need to act upon it. If a particular commitment is important to a user, they are more likely to indicate as much when presented with an operable visible notification, wherein the means of dismissing the notification is a flick in a measurable direction. A flick upward would indicate increased importance. A flick down would indicate decreased importance. A flick sideways would be a simple acknowledgement with no change in importance. And, lastly, the absence of any flick would indicate that the app did not have a user's attention.

Prompts may use means external to the direct control of the app to get the user's attention. For example, the software may send asynchronous messages at the appropriate time, it may add alarms to a device's queue at appropriate times, or, in more time-sensitive and important situations, it may contact the user through synchronous means, with the notification mechanisms built into such means. In the case of sending an asynchronous text message or using a mobile device notification, prompt information may be provided, or a link may be provided to take the user to the app for reading of the prompt message, or both.

The visible notifications may be accompanied by an audio notification to alert the user. A user may further specify a certain preference for one or the other method or the app may learn the user's preference and bias notifications in the direction of what seems to work best for that particular user. To that end, the visual notification may provide an opportunity to increase or decrease the desirability of a plurality of notification types. The baseline urgency for a given notification might be based upon a combination of urgencies of multiple calendar layers. For example, a user may not be worried so much about their time, but if they are responsible to the time of others or for the management of a specific high-priority resource, that would inform the notification urgency, as well. A cost function may be assigned to being late for transitioning at any layer of the calendar, and those cost functions rolled up into an overall importance for the notification. Each calendar layer may have different time-boxes, with varying levels of rigidity. The rigidity of a time-box will also inform the app of the sense of overall urgency associated with a given notification. Said notification may combine several layers of alert (e.g., the car that you share with your spouse needs urgently to be back home by 1, so you will need to leave in 15 minutes to get it there.)

If the user does not quickly acknowledge a given notification when presented, a timer may be set to present another notification to the user, at which time the notification mechanism may be modified for maximum effect according to the present sense of urgency. When a user acknowledges a notification, it may naturally reduce the urgency. When a user does not, it may increase the urgency. The more urgent a notification, the more likely it will be to have either a changed character, an increased level of intensity or both. A changed character may comprise a changed sound, duration, volume, communication method or even recipient. When a user is not acknowledging a prompt, the app may alert those impacted by the potential for them to miss their commitment.

When a notification is acknowledged with a flick motion, the direction of the flick may indicate the direction of change of importance of the notification. Further, the origin of the flick may indicate a desired change in the intensity of a particular type of notification (e.g., visual, audio, haptic, asynchronous message). Further, when a notification is acknowledged, the app will make note of having the user's attention on the associated device and will reduce the likelihood of presenting notifications to other devices in the possession of the user.

Note that the user input for the described flick will depend upon the type of device. A mobile phone will typically use a finger press location and associated flick direction. A desktop or laptop computer might use a mouse pointer location and associated flick direction upon the click of a mouse button, or it may use other means for the user to indicate the information conveyed in the flick on a mobile device, for example selectable buttons. Multiple mouse buttons may also be used with different meanings assigned to different buttons. The app may support touch screen functionality, in which case it may function more like a smart phone app.

A sequence of notifications may be used to form a named strategy, creating a progression through types of alerts and intensity thereof, choosing among such elements as volume, frequency, communication medium, sound, haptic feedback type and intensity; visual feedback size, rate, duration, and information conveyed; number and order of platforms or devices. These strategies may be given user-selectable names or software-assigned names, and those names may be associated with a given sequence. (e.g., Critical→phone badge first 10 minutes in advance, then if no ack ring phone, then if no ack ring computer, then if no ack buzz both, then if no ack strobe flash, then if no ack call my spouse, etc.). The user may also choose more subtle means of feedback, for example changing a color or emoticon when a user does not appear to be following their plan. They may also choose specific notifications to associate with certain notification types (e.g., a different sound for a break than for the end of a collaboration). These strategies, or the selection thereof for a given prompt, may be adjusted by the user or by the app. The strategies may be sorted into an ordered list for selection by the user and then adjusted up or down in importance by the user or by the app depending upon a number of factors such as user-indicated need through a simple form of feedback, such as the flick direction method described elsewhere herein. The app may also modify the strategy when new information becomes available, such as, for example, a user being on a tight schedule after inserting a GetToDo into their time-box at the last minute or the user being focused on the past or future in the app when they are committed to showing up at an imminent event, or the user having one of at least two different levels of activity with the app. For example, if the user is largely inactive, prompts may be sent to a plurality of devices or using a plurality of communication methods, or they may be sent to a current or future collaborator.

### (14) Personal Intentions: Values and Profile Interview Short Course(s)

The essence of a user's profile is a statement of their values. It is the job of the interview to draw that information out of them in a friendly and engaging way. At the same time, the interview may draw on the four cornerstones of Nir Eyal's “indistractable” practice as described in the following paragraph.

The indistractable practice is a preferred method for addressing the general level of dissatisfaction with the modern world. Many users are not happy with how they spend their time, but they don't know how to address it. As a company, our strategy is to do this work, ourselves, feeling through how to make ourselves indistractable, and in doing so, figuring out what trustworthy tools are needed in place of untrustworthy ones or generally outdated ones. Collaborations and Scheduling, then, are about formalizing the interview we might want to do for ourselves and each other, to determine how each of us wants to spend our time. That is, what triggers do we want, and which ones don't we want? What feels like traction to us, and what feels like distraction? And how do we set up our lives to minimize the unwanted triggers and temptations to distraction? Eyal's first book, Hooked, talked about how to build a habit-forming application. Bucher's book, Engaged, talks about how to design for positive, trustworthy, behavior change. This is where so much of the promise of the internet has run amok. Web browsers, e-mail readers, social media and the like all lead us down distracting rabbit holes. How can we transform our relationship with these sources of distractions? Where do we need to replace certain functions or sequester them into times and situations where they can be of the greatest use?

The app will utilize concepts from the indistractable model described above.

### (15) Hack-Back External Triggers

One imbalance in our present telephone system is that the calling party can interrupt whatever someone is doing without paying for the privilege. This leads to distortions in the free market, giving the upper hand to unscrupulous telemarketing strategies. The app will allow the user to hack back many of these unwanted triggers, giving the user more control over their life in a simple and effective way.

In Europe, the calling party pays the cellular charges. So, we can model ourselves from them a bit, only in our case, we can have the calling party pay the called party, and not the phone company! In general, we will want to encourage the user to use “do not disturb” and other such functionalities to hack back as many distracting notifications as possible. At the same time, the app will encourage users to develop relationships, such that they can recognize if someone who is calling is outside of their sphere of trust and therefore they can safely let it go to voicemail. Some people have customer service-oriented roles, such that they can't just let some calls go to voicemail, or they will want to address those voicemails as quickly as possible. The app may queue voicemails or other messages for review by the user at the appropriate time, when the user plans to handle such messages.

### Privacy and Information Sharing Decision

Likewise, some famous or sensitive people, will value their privacy more than others. These users may indicate a greater degree of privacy than average whereas someone who is less sensitive might indicate a lesser degree of privacy. Privacy, then, would be used in least in part to decide which users have access to all or parts of a user's profile, or even to their discoverability. Their privacy and/or discoverability may also be specific to a certain shared interest group. Privacy levels may also be set for calendar information, either manually or as part of a default setting in response to a user's stated privacy needs and/or in response to the urgency of the calendar event at one or more layers of the user's calendar. So, this process may be applied to all of a user's sharable information or one or more subsets thereof. Sharable information may include up to the user's entire profile or may be reduced by the user according to their desire for privacy and trust. A user may further be able to designate who can see their information by a combination of one or more factors, including a total number, a trust threshold, a degree of separation, or by one or more user-selectable and named algorithms.

Text messages, particularly group texts, can be a distracting cacophony of notifications. We will want to help people set up strategies for how to handle text messages in the context of their intended focus in the moment and the source of the message. Some text messages need to be urgently read, but relatively few of them. Others can be appropriately grouped for the right time of day, perhaps along with scanning working e-mails.

E-mails, likewise, can be scanned, with a flagging process for what to read, and a means for determining when to read and respond. Here, a commitment device is formed. “I want to read this message this afternoon during my e-mail read and respond time.” The user needs to trust that this flagged message will be readily visible during that time, so they won't disappoint the sender.

Commitment prompts can be graded by importance of the time-box or commitment, and this grading must be readily done, generally using the “flick up” or “flick down” method that we would like to be available across multiple windows of the app. Flick up to make the notification more urgent, with the highest urgency equating to: “Don't let me forget this!” and the lowest equating to effectively no notification at all. This “flick up” or “flick down” method can be used for text message or e-mail notifications, as well. If an e-mail comes in that looks important, flick up. If one comes in that looks like junk mail, flick down once or twice to send it to oblivion. Flicking at user-defined angles may also be used to indicate other actions, for example differentiating between not sending a prompt again and simply lowering its volume or periodicity. Likewise, a flick in a certain direction or a different motion, such as a double tap or right click might evoke a menu of context-dependent choices.

### Swipe or Flick Rapid Expression

In general, swipe boxes or regions of the device screen may take, as input, the presence of a swipe or flick, and its direction. As described herein in several aspects of the invention, a standardized mechanism is provided to the user to indicate positive, neutral or negative feelings about the activity they are involved in at the present moment. An upward direction is used to indicate positive feelings; a downward direction is used to indicate negative feelings and a sideways direction to indicate neutral feelings. The screen may provide visual feedback to the user to indicate the meaning inferred from the direction of the swipe.

Swipes may be used to indicate a user's feelings about an interaction with another user. Within the context of an asynchronous conversation, for example, a downward swipe may be taken as a reduced level of interest and would downgrade the tendency to be notified about future messages. In the context of a synchronous conversation, an upward swipe may inform the app of a user's interest, increasing the desired duration of the conversation from the user's point of view. In the context of an ally, the app may interpret swipe direction as a desire to modify the ally's trust level. In the context of a GetToDo, swipe direction may be used to change a GetToDo's priority. In the context of any timed activity, swipe direction may be used to add or shorten time for that activity, whether it is a break, a future commitment, in a time-box (as viewed from the home screen) or within a primer, to indicate enthusiasm or disinterest for a topic. If a future commitment is associated with a swipe, the swipe direction would indicate a greater or lesser importance of that event, potentially impacting prompt strategies or scheduling options. Prompt strategies may also be adjusted in response to swipe direction on a prompt window, whether that window is delivered by the operating system of the phone or within a pop-up window of the app.

In another example of flick or swipe direction, a left to right flick may be used as an indication to “go back” whereas a right-to-left direction indicates a desire to move forward.

### Make Time for Traction:

At the core of making time for traction is the time-boxed calendar, and within it, a certain amount of time set aside to examine prior use of the user's time, allowing them to adjust future plans appropriately. This might be done at some other interval than daily but daily is a good start. Most people, we hope, would be willing to spend 5-10 minutes per day on such things.

The Post-Growth Institute (based in Ashland, OR), talks a lot about how our economy can work once we have gotten past the frenetic profit and population growth phase of our species. They talk a lot about “offers and needs” marketplaces. Let's note that we can allow a user to decide who is able to “call” them, but not actually allowing address or phone number info to be shared to anyone who is not trusted or vouched in somehow. Another shortcoming of the present system is that we can't block someone who is texting us with spam. So that is another benefit to tightly controlling phone numbers and notifications.

Making time for traction implies that we have some sort of regular, on-going, dialogue with the user, to help them with a few psych tips and lead them to the changes that they want to make for their own sake, as well as support them in making these changes happen. Defining values is an important on-going process. It starts with offers and needs and then can progress even deeper. Let's start with an example.

Prevent Distraction with Pacts (Values: Defining Offers and Needs)

Medical students are trained using the “See one, do one, teach one” model. In reality, they probably see a lot more than one and do a lot more than one before teaching, but you get the idea. So how about if we oriented our offers toward what might bring us joy? A user may have a weak back, so they avoid lifting much of anything. But they still need exercise. So, they think back to their childhood days, mowing lawns, and they think to their adult days of digging ditches and even of commercial fishing. Now that was great exercise, and they would love to do more of it. The user may have a bunch of things that they would like to do more of:

Offers: what do I want to do for others? (above example)

Paid services (stuff where I need very little guidance):—key area for reviews, pricing, and financial transaction back-end:
Mow lawns ($20/hr. or call for price)
Dig ditches or holes (put in drains and irrigation)—($15/hr.)
Diagnostics (pro, $100/hr.)
Software Design (pro, $100/hr.)
Develop patents (pro, $150/hr.)
Commercial Fishing (negotiable, on share basis)

The app may provide for references in addition to standard reviews, allowing people to contact those who have gone before them. References may be done in exchange for halos or other compensation from the person asking for the reference.

The above definition of example offers may be packaged into a plurality of “yellow pages” listings and these listings may be made available to search across the software's network, as privacy settings allow. In this example, the lawn mowing offer may be only for people in the user's friends, family, and close neighbors, whereas the higher priced offerings might have a broader applicability to anyone in the user's state, country or even the world.

Internships/apprenticeships/volunteer (where the user may need a mentor to feel confident and is willing to work for less or free), for example:
Teach hockey and a few other sports (community service)
Mentor autistic children (community service and personal growth)
Handyman services—mostly diagnostic work, helping friends figure out what they can do themselves and where they need outside help
Building Design—helping others and doing more, myself
Writing—blogging, eBook, memoir
Inquiry/psychotherapy

Beginner (where the user is willing to pay for coaching), for example:
Play the bass guitar
Read music
Understand chord theory
Self-management: I am willing to pay therapists, psych professionals and other mentors in my life.

Paid needs, for example:
Food (typically paid)
Housing/utilities (typically paid)
Entertainment (typically paid)—movies in a theater, concerts, plays, paid TV
Shared TV subscriptions (Netflix, Fubo, Sling, HBO, AppleTV, etc.)
Healthcare (typically paid)
Trainer
Gym
Physical and emotional therapy

Free needs, for example:
Co-exercise (typically free)—tennis, hockey, hiking
Co-socializing (typically free)—movies, watching hockey, games, simple visiting
Co-work (accountability structure, typically free)
Tinder-like functionality might fall here.

The app may provide auto-completion to help users define their offers and needs with a minimum of verbosity and duplication of categories. It may also provide flexible search structure for people to be able to find what they are needing, with synonyms in play, as well.

Each time a user forms a commitment, it is a commitment device or pact. We want users to use these commitments to form good habits and let go of the ones that they don't feel good about.

It is worth highlighting the shared subscription model among friends and family. Many services allow for sharing, but these are rarely used. Some services may have been developed to allow for such sharing, but there is a fragmentation to the marketplace if there is no readily searchable central listing that goes beyond such a single special purpose. The app may encourage subscription sharing within each user's trusted social network first, and then add people outside the network, only as the user desires. The sharing could allow for automatic regular compensation from the users benefitting from the subscription to the user paying for the service. Any fee charged by the app might be reduced for those in one's social circle to encourage localization of transactions within one's social fabric.

### (16) Review Concepts

Reviews and references are meant to be associated with paid services in the offers and needs marketplace. People can earn halos by providing references or, at a lower rate, quick reviews (e.g., thumbs up or down, only). The idea is to provide mechanisms for building trust, where the reviewer does not have too much power. For example, the recipient of a review may have the opportunity to rank the quality of the review on one or more scales, and that quality score may be reflected in the reviewer's power. The app may also allow for direct references for the bigger decisions that people might want to make (like hiring a professional for a big job). In one embodiment, the application will allow users to indicate that they are willing to provide references for one or more allies in their network or any product or service they have paid for, and also allow them to be compensated for the reference by either the person that they are providing it for, the person requesting it, both or neither. The compensation may be in the form of a gift to charity or the company providing the software, in the event that a user does not feel comfortable taking direct compensation for a reference but wants to avoid being “taken advantage of” with free references.

The price paid for a reference may be on a sliding scale, as described elsewhere herein. The reference may be in written form and therefore attached to the associated offer in review form. The pay for the reference may go to the provider of the reference, to a designated charity, toward the maintenance of the app or some combination of two or three of these recipients.

### Interview Narrative

A values interview narrative, which is meant to be presented to the user in an unfolding set of teachings and questions, may be used to lead a user through an inquiry process, both teaching them that process and noting the answers that they provide for development or modification of the user's intentions.

### (17) Master Internal Triggers

What regular rituals does a user have available to help steer them into psychological inquiry and/or spiritual practice like prayer or mediation, along with some introspective time to reflect on their goals and dreams, as well as what upsets them? It is so easy in the modern world to out-source our feelings to others, including employers, political leaders and loved ones. What we want to gently encourage, is a movement toward taking 100% responsibility for our own feelings, health, and general well-being. As one noted psychologist famously says, “If we don't feel our own feelings, others will do it for us.”

We will want to get to some tricky questions around some potentially touchy areas, and yet there are some great tools out there to address a vast majority of the generalized angst our population is feeling over such huge issues as climate change, political polarization, and a general sense of not feeling heard . . . not heard by our governments, not heard by our loved ones, and honestly, not really heard and trusted by our own selves! At the core of this process, we want to rebuild trust in ourselves. We want to spend time working toward our own dreams and not in distraction. We want to build relationships with great intention, and let go of, or de-emphasize, those that are not serving us.

Mastering internal triggers starts with recognizing them and getting curious about them with some form of inquiry. Recognition is the beginning of the RAIN process described so eloquently by Tara Brach. What we want to do is encourage users to master a process like RAIN, Byron Katie's four questions, or the loop of awareness taught by Katie Hendricks. Some will want to perhaps do this daily. Others might get adept at recognizing upsets in the moment and dealing with them promptly. Regardless, we want to support the user in finding their heart's desires. Feeling their feelings in times of discomfort is the way through, but it can be tricky. We will want to be as gentle and loving as we can possibly be in this process, encouraging friends to help each other with such processes and improve listening skills within groups of friends and family.

One means for encouraging this mastery of internal triggers is a reward system. In the parlance of Tara Brach, that is the “N” for nurturing self-compassion. In psychological terms, it is whatever gives us the dopamine hit that is so essential to habit formation. In Nir Eyal's terms, it is a variable reward. We can give the user tons of positive feedback and help them to create flow from this work. After the RAIN process, there is often great clarity. That is the time to be setting actionable intentions, and we want to provide the tools to give the user a sense of flow, so they are really able to listen to themselves and gain trust in their ability to manage their own lives. As an incentive for this kind of work, we want to provide as many halo-based or other rewards (preferably variable) as we can, as well, especially in the beginning, when the user is just picking up the good habit of forming good habits!

Time-boxing is a key mechanism for recognizing internal triggers and raising them into intentional consideration. We have in mind a multi-layered calendar, as described above with this Collaborations and Scheduling, primarily concerned with layer 3.

FIG. 14 is a short courses window 1400 that shows progress on a number of short courses, including personal. Short courses are intended to both educate the user and elicit answers to key questions that may be used to populate the user's profile progress 1410, time-boxing progress 1420, allies progress 1430, and collaborations progress 1440.

### Training Method

This is where we use positive feedback to help users set their own goals and “game” themselves. We can also add halo earnings to this screen. Rather than having an ill-defined progress indicator, we envision allowing each user to define how much progress they want to make. For example, clicking on the allies bar will allow users to define what constitutes progress: number of allies entered, number of allies invited or joined, number of allies with well-defined ally information, number of family members entered, invited, joined, number of colleagues, etc. They may also add new courses that follow well-defined rules and then provide positive visual feedback as progress is made. Calendar intentions are similar.

The profile screen will start with the user's ally information and then use a finite scroll method to fill out more “about” information, such as job, family, education, interests, etc. The ally section is the most important and will be very similar to entering ally information of others. A user must, at a minimum, have at least one address. The app may allow them to provide and store many more, though.

The app may provide a debriefing screen to allow the user to rate their actual use of time over, for example, a given day in the recent past, and to use these ratings to form positive intentions for future change. The app may also present a rating screen for, for example, a given day in the near future, to ask the user to rate their planned day or any time-boxes therein in terms of, for example, meaningfulness and enjoyment.

### (18) Time-Boxed Calendar (Layer 2)

The app will provide a means for keeping a time-boxed calendar (layer 2 of the calendar). The app will maintain a model for how each user wants to spend their time, and present each time-box context to the user on the home screen in a timely manner, such that the user has the information they need to stay oriented in time and intention in front of them and no unnecessary information beyond that.

This time-boxed calendar is primarily concerned with how the user wants to spend their time. *Who* they spend time with is the topic of the Collaborations and Scheduling module and layer 3. *How* they spend their time is the topic of Personal Intentions and layer 2. In the beginning, the user must specify much of this, but the app may provide suggestions, based upon how the user tells it they want to spend their time. That might include the ability to see how those they admire budget their time (with permission, of course), and having the ability to easily adopt their strategies.

The app may provide the ability to share halos, like a tip or thanks for some good work. The halo may also become a form of compensation in the offers and needs marketplace.

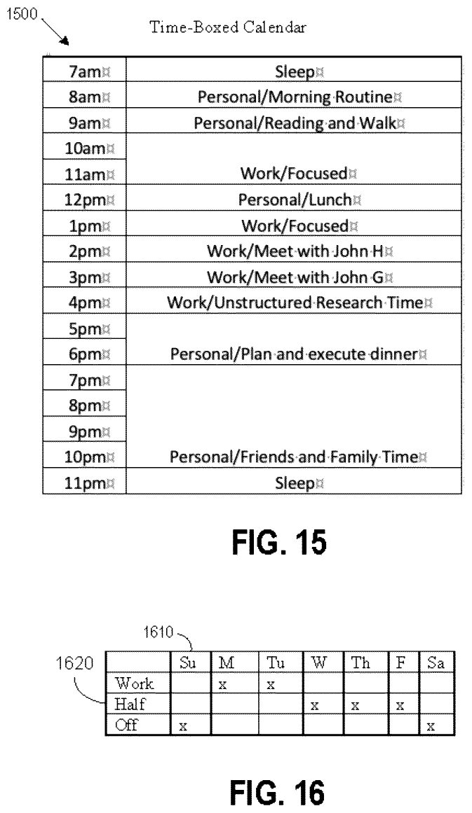

FIG. 15 shows an example of a time-boxed calendar 1500. Time-boxing our calendars can set up a first layer of intent, allowing us to establish commitment devices to address what we think is important, when it feels appropriate to do so. Above is an example along these lines. The app may form an “intent” calendar, which has nothing but the higher-level idea of how the user wants to spend their time repeating day-by-day or associated with a particular day template. The app may provide the ability to make and maintain a GetToDo list for each of time-box, as well as the notes, files, bookmarks applications and/or allies that the user may call on to address these GetToDos.

First, though, it will be necessary to identify workdays, days off and any other type of day (for this example, we have defined half workdays).

Table H (FIG. 16) is an example day naming table that defines which days of the week 1610 match a particular layer 2 calendar template 1620. The template names are meant to be user-defined or at least somewhat flexible, ranging from 1 to 7 (or perhaps even more) different templates. The idea here is that new users may copy the layer 2 template from close allies (or famous people) that they admire, such that they don't need to build their own from scratch. The above table may, for example, include exception cases as well, such as vacations, anniversaries, birthdays, holidays, travel, and so forth.

When a travelling template is selected, the app may allow for rescheduling of commitments when they are either not rigid and/or impractical, allowing for shifting the layer two intention to match time zones and work around periods of unavailability due to travel.

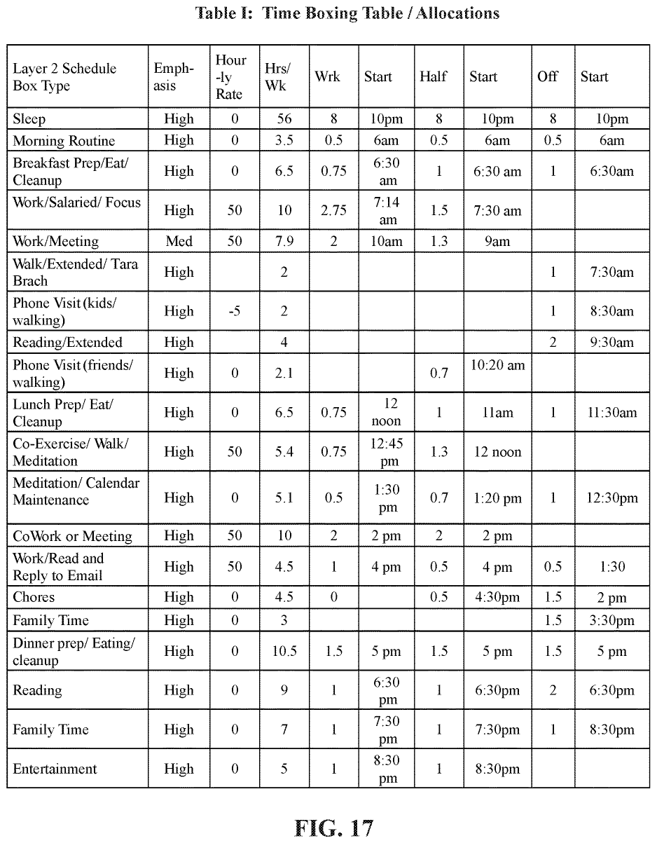

Table I (FIG. 17) is an example time-boxing table that is useful for layer 2 calendar allocations. It may either be used to fill out a calendar, or it may be filled out based upon the calendar. These are only layer 2 allocations signaling intent, not firm commitments. So, they might be kept fuzzy on the calendar display, and in the background/deemphasized.

Table I in this example can be utilized as something like a spreadsheet, automatically updating the times and totals when a duration is adjusted and automatically updating the durations and totals when a time is adjusted. In one approach, the user may be encouraged to have all twenty-four hours allocated by not being allowed to save until all twenty-four hours are allocated, as long as it is clear that this is the case to the user. (We don't want them clicking on a greyed out save button but rather being gently guided to complete the allocations.) The “Unstructured” line may be set up to hold all unallocated time, such that twenty-four hours are always allocated. Allocating more than twenty-four hours may be blocked or discouraged, or simply balanced by negative unstructured time, with a similar blocking mechanism to keep the user from saving an over-allocated layer 2 table.

Note that the user may be able to set contextual rates, for example higher rates when a less-desirable time is selected, based upon the need to do extra overhead, travel, or need to build in other forms of down time. In this way, for example, appointments may be appropriately grouped, by steering clients to book adjacent time-boxes and then reducing the price of the next adjacent time-box. Rates may apply to certain time-boxes or listings in the private and/or public marketplace, and those listings may reference one or more users' availability for the listing and form commitments that are placed on the user's layer 3 calendar during time-boxes that are marked as available for such purposes. The formation of these commitments may be automated, require user approval, or allow the user to take a more active, manually intensive, role in the booking process. The app may provide for a selection of booking strategies, such as manual, approval, automatic, clumping, distributed, focused, revenue-maximizing, phasing out, or building up and execute upon these selected strategies.

The table in FIG. 17 may be added to our calendars with relative simplicity by adding a start time to the first entry (sleep) and then automatically calculating the rest of the start times in order.

### GetToDo

A user may create a “GetToDo List,” where the emphasis of the name is to encourage people to see all of their tasks as something to look forward to: something they “get” to do. One challenge of keeping TODO lists in modern society is that, particularly if they are on paper, keeping track of the lists and then managing them can become a hassle. If they are kept in a computer or smart phone, the user may get distracted by any one of a number of powerful external triggers such as advertisements, social media or games. For this reason, the app eschews advertising. Another challenge with TODO lists in computer or smart phone app is that they are not ubiquitous among the typical user's social fabric, including friends and family. For this reason, for the app to be widely adopted, the user may not meet a pay wall as a pre-condition of using the GetToDo list and other multi-layer calendar functionality.

Fundamentally, the service will allow a user to create a list, and also to populate that list with one or more individual tasks. Individual tasks may contain subtasks. Unless such application would be nonsensical, anything a user may do for a task may also be done for a subtask. The user may perform the following functions: create/add a task, delete a task, modify a task, mark a task as “complete,” and assign a task to a certain time-box associated with a calendar layer, indicate one or more allies to be associated with a task, make notes on a task, and assign a priority level to a task (where the list may be automatically sorted/organized according to priority). If a task has a due date/desired completion date, and the user has broken down the task into subtasks, then the app may populate the subtasks into the user's time-boxed calendar such that the last subtask will be completed by the due date, and other, earlier subtasks will be completed (or suggested by the app) in appropriate order, as early as practicable.

Collaboration GetToDo: A collaboration is a commitment that is kept as a GetToDo list, showing up in the one or more time-boxes that it is contemporaneous with, along with the additional attributes that may be associated with a calendar commitment, such as start and stop times, duration, collaborating allies, location, conference bridge, shared notes or files, URLs, etc. In this way, external user commitments become a property of an intention-focused time-boxed calendar, rather than the primary concern of the user. Collaborations may be known by other names. For example, as meetings during work times and get-togethers during personal time.

Dynamic GetToDo: While a user may, from time to time, find themselves with extra/spare time, and may independently consult their GetToDo list, the app may identify opportunities that are conducive to a particular task because of some combination of characteristics of the task and the user's context. Task characteristics may be expected duration, location, resources required, or a particular ally. The app may identify suggestions accordingly, for example, if a user finishes a collaboration early, the app may suggest a GetToDo task that would take approximately the amount of time freed up by the early finish, if the user had indicated how long they expect it to take. Or, if the user had indicated that a certain task had an associated geographical location, the app may remind the user if the user happens to be close to that location as a good opportunity to complete the task. Or if the app notices that a required ally is available, the app may suggest an impromptu collaboration. These suggestions may occur unprompted, if the app identifies a high likelihood of relevance.

Alternatively, the user may create a GetToDo-placeholder time-box on their calendar. Once this time-box begins, the app will suggest a random task from the user's GetToDo list, where the randomization is not absolute, but weighted, where the weighting system may include user-indicated urgency/priority and also relevant contexts as above under Dynamic GetToDo.

If, for any reason, the user wishes not to do the particular random task suggested by the app, the user may decline the suggestion. If the user declines a suggestion, the app may suggest another task from the list following the same or similar logic.

The user may divide a task into subtasks, smaller and requiring less effort, and within the app, assign those subtasks to a certain calendar layer and time-box. The user may divide the GetToDos into subtasks with different names than the more generic GetToDo. For example, they may “GetToBuy”, “GetToWatch”, “GetToPlay”, etc. These “GetTo . . . ” names may be presented to the user in a selectable list, to help prompt them to break the larger “GetToDo” intention down into component parts. These calendar assignments may be private and only include the user themself, or they may feature connections to one or more allies or potential allies. A user may also assign or otherwise share tasks or subtasks to existing collaborations or provisional collaborations. If the user is linking tasks to a provisional collaboration, that provisional collaboration may form the basis for an invitation to collaborate, sent to one or more other users. A user may share tasks or subtasks to a pre-defined group or collaboration.

### Calendar Sharing

A user may allow visibility of their time-boxing table to others in their social fabric. This sharing may be controlled by a user-controllable permission setting for the calendar information ranging from private to public or a blend thereof, wherein the blend might be based upon shared interests, trust levels or user privacy. Furthermore, blended privacy might also be applicable to a mix of information elements, such that, for example, certain high-level information is more publicly available, whereas more specific details are withheld for the sake of privacy. Famous people may choose to publish their time-boxed calendars, so that people can adopt the habits of those that they admire. This sharing of calendar information may also be offered for compensation, either directly, to a charity or to the app. The “unstructured” line allows people to slowly allocate their time, such that they do not try to do it all at once. It is simply 24—total hours allocated for each day. (relates to Personal Intentions)

The Layer 3 algorithm for automated collaboration setup may include:
1. Ranking potential collaborations by individual desire (shared interest and mutual level of trust/interest)
2. Displaying availability and reciprocal interest among the above lists.
3. Setting up micro-collaboration/date for a date (1 to 5 minutes)—may be message-based
4. Setting up an initial collaboration (15 minutes to an hour)
5. Setting up follow-on collaborations (regular meetings)

A swipe window or button can be added to each applicable interface.

Another method for forming intended relationships is a simple meeting invite, where a member can invite a non-member to meet. This would likely be a text or e-mail message with two links: one to schedule the meeting and a second one to become a member, if they are not already one.

The names on the diagram would get too crowded as allies are added, depending upon length of name and screen size. At some point, the names may be shortened to short names, just initials and then small icons and finally simply pixels or small groups of pixels.

Each entry is color coded according to a user's availability. The range of colors may be associated with the “cost” of interrupting a user in a given moment. (Users are able to set different cost models for their own time using the Personal Intentions functionality, whether it be for a real-time interrupt or for a planned meeting at various times of day.)

Chat sessions between users and groups of users may be initiated from this screen, as well. Here the idea is to allow users to search their allies for groups of allies according to a criterion they set in the moment, applying to the present time, to a future time, or to a future range of times, helping each user to set up appointments.

We have a concept of “chat roulette”, which can automatically populate a chat with present allies or even extended allies, not in the user's ally list. For example, a first cousin of a famous person may be difficult to reach directly, due to having few close allies. That cousin's mother might be easier to reach and could set up a chat between the two cousins. because she has a deeper trust relationship.

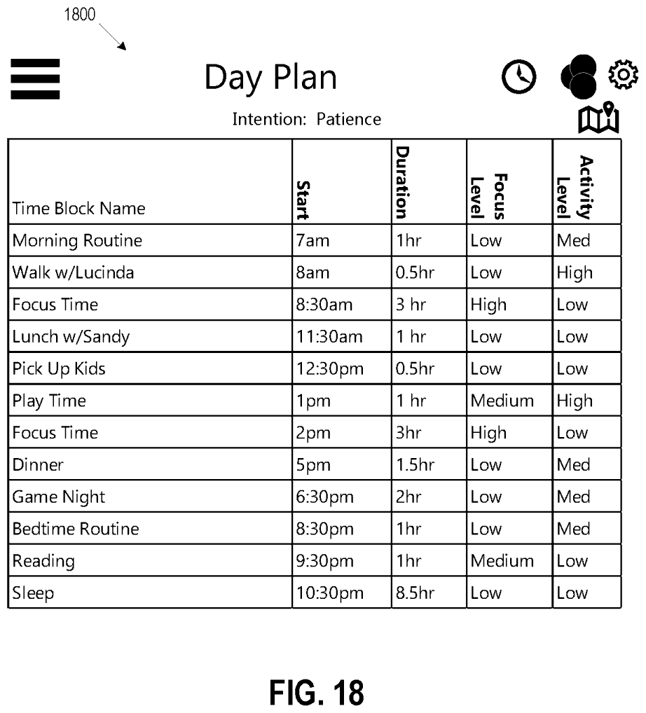

FIG. 18 shows an example of a day plan 1800, which provides a list view of the day plan, focusing upon calendar layer 2, but with information from layer 3 added in (in this example). In some embodiments a pictorial or map view may also be made available by clicking on the appropriate button (in this case a map icon). The list view may have flexible column selections, available from the cog/settings menu. An analog clock face helps keep the user oriented in time. Each time-box is selectable, to allow for the user to edit the time-box or delete it. This screen is intended as a quick reference, viewable at a glance throughout the day. The user will be encouraged to spend the bulk of their time on the home screen. This encouragement may be in the form of, for example, a “go” button on the day plan screen.

### (19) Security, Privacy and Permissions

Here, disclose a few different facets of privacy and security meant to secure a user's trust.
1. Application security (signing in and out from multiple devices and connecting to a cloud or PC server).
2. Ally identification, confirmation, invitation and acceptance will follow a prescribed flow. As a first step, a user would search for allies using keywords they know about them, such as name, e-mail address, phone number, physical address, one or more schools, etc. If they found one or more listings based upon this search, these listings would represent potential allies. The user might request a confirmation of identity along with a private note explaining to the potential allies who they were, as well. The potential ally then would have the option of simply confirming their identity, denying the identity, simply ignoring the inquiry or making a request for alliance. At this point, the user would receive said information and act accordingly, either confirming the ally request, sending one of their own or letting the process drop.
3. Contact sharing security and privacy provisions:—Contact sharing may be limited to first degree allies. Ally sharing would be limited to certain second-degree allies, according to trust and shared interest, where typically only some fraction of each user's ally lists would be available to their allies, based upon sharing algorithms described herein. Users with lower privacy concerns may choose to make their profiles more broadly searchable, for example either to the general public or to users with an application-provided trust level, where the trust level would be developed from a combination of factors such as length of membership, duration of the relationship, number of positive interactions, number of positive reviews, user-indicated quality of interactions within the context of the relationship, number of allies who trust them at a certain level, those who have completed one or more certain short courses, etc. Likewise, if an ally acts in a non-trustworthy way, there will be ample mechanisms to reduce the trust level that a user associates with said ally, remove said ally from their social fabric and/or to report said ally to the app, thus lowering their application-determined trust level and potentially identifying them as a potential bot or otherwise non-trustworthy user.
   a. When inviting an ally or accepting an ally invitation, their trust level must be designated along with the nature of the relationship. This may be done with the following method:
      1) Direct-designation: A user may assign a qualitative trust level to an ally from a drop-down list or lists of high- and then low-level relationship descriptors, and the service will remember how much that user “trusts” that ally by storing the quantitative trust level associated with the selected qualitative relationship descriptors.
      2) The app may suggest a default trust level based upon the user-designated nature of the relationship and the user's privacy settings, and the user may manually adjust it before sending the invitation or approving the alliance.
      3) In general, each user may be free to set the trust level for each of their allies as they see fit, with no reciprocity even possible. Trust and privacy levels will be held confidential to each user.
4. At any time that a user receives a message from one of their allies or views their ally profile, they may be able to indicate the quality of the interaction with a simple action such as a swipe. Thus, this quality may be indicated contemporaneous with said interactions or at any time. The device-based app may present the user with a request for clarification where there is any ambiguity. For example, if a message is received from an ally with disappointing news, the user may down-swipe to reduce their trust in that ally. The app may then ask for clarification, to determine if the user is downgrading their trust in the writing skills of the ally or in the trust level of their entire relationship. In the former case, the app may reduce a review score for that ally's writing which may be particular to that relationship or, if the message was sent to a plurality of members, reduce the application-level score for the quality of their writing. The opposite is true for positive swipes, indicating increases in the ally's respective scores
5. Calendar sharing security, as discussed elsewhere herein, based upon trust and privacy settings.
6. Cloud/server/system security-A key issue for us if we are going to be holding people's deeply personal information. Encryption may be used for any data stored in the user's devices or in the cloud. It may also be used for messaging between users.
7. API security-Certain “hooks” may be provided into the app for third party apps or services. These hooks will be treated like any other ally or public marketplace relationship.
8. Design security (open source)
9. Cryptocurrency/purse interfaces
10. Encryption/storage/comm issues
11. Credentialing across multiple platforms.
12. Password safe functionality, with enhanced security for sensitive accounts or information and potential integration with 3^{rd} party applets for this functionality.

“The service” described above includes both user device-based app and any cloud-based resources used to support this software.

Security will be a feature; however, we want to make this app easy to use, and so we also want users to have the option of using more simple approaches. Security on our servers, whether hosted by a cloud service provider, an ISP or a user's own personal computer, will be important. One idea for first order ally security (to avoid impersonation) is to allow for a brief dialogue when someone is a new member, to make sure that they really belong. This dialogue might be fairly stilted . . . how do you know each other? In what shared interest? Describe something about your relationship that a bot wouldn't know.

In alternative embodiments additional features can be added, for example meetings and messaging with multiple users, offers and needs searches, semi-automated meeting management and increased sophistication for handling of halos as well as possible hard currency. We can also start to think about elements of a password safe, credit card storage, health emergency allies and other secure information. Emergency allies are a great way to be able to find someone when they are non-responsive, for whatever reason.

The above-referenced password-safe functionality may help users retain their username, password, and other information as part of the record of a relationship with a given marketplace listing or ally. For example, if a subscription is shared, the subscription account information may be contained in one party's profile information and viewed there on request only by those sharing the subscription. In this way, when such information is changed it need only be changed in one place.

### (20) Scalability and Home Screen

One key user-facing element is a feedback mechanism that helps users to feel like they have a direct line to the developers. The app may provide positive incentives for power users to contribute their best ideas, perhaps including compensation, praise or recognition.

### (21) Contextual Information Presentation

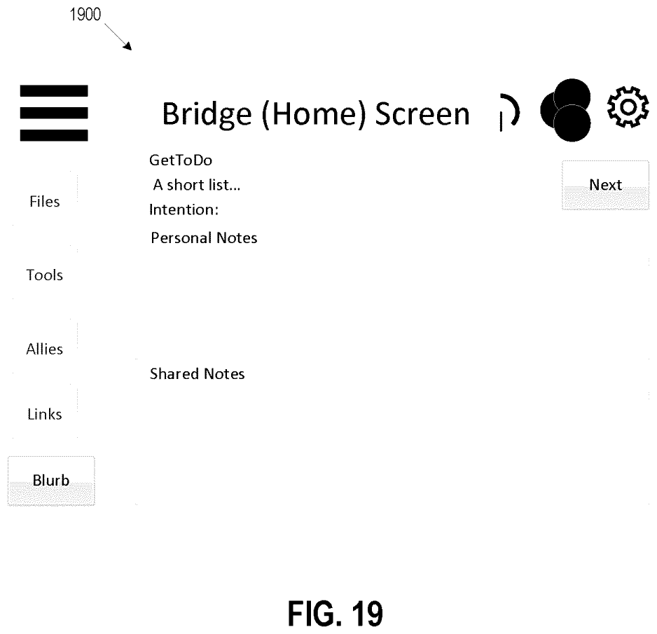

The app's home screen may look something like FIG. 19, which provides the user with an automatically changing context, depending upon the tasks at hand. The contexts may also be manually selected by use of “next” and/or “back” button or similar functionality, such as left and right arrows to move forward or backward in time. FIG. 19 includes a countdown timer with a second hand, access to the purse and access to the GetToDo items applicable in the present moment. These GetToDos may be individual, shared, or both. The GetToDos may be given different names, and they may be broken out as individual vs. shared tasks. Different names might include, for example, “GetToBuy”, “GetToSell”, “GetToClean”, “GetToCall”, “GetToCreate”, etc.

The home screen may present contextually relevant information to both the user and their present collaboration, sharing “shared” GetToDo list information on the screen of all collaborators. It may also present a shared note space that all collaborators may view and those with permission may edit. And finally, the app may display any personal GetToDo list information on the screen of each individual user as well as sharing such information that is relevant with other collaborators, as they request to see it and are allowed based upon the information owner's privacy settings and their stated understanding of the nature of the relationship, with an associated implicit trust level.

FIG. 19 is an example of a home screen 1900, which in this illustration is labeled “Bridge”. In many embodiments, the home screen may be shared during collaborations. The home screen may include features such as: 1. Context-specific bookmarks, 2. Context-specific file folder, 3. Context-specific app list, 4. Context-specific allies, and/or 5. A file-tree type of mechanism which allows these four to co-exist and for the user to add “note” files wherever it seems appropriate, with ease. In this way, all the user sees are one or more higher level resources. As their calendar flips to some new event, the user will see the appropriate tools for the tasks at hand.

Sharing of resources on the home screen in the context of a collaboration is based upon a plurality of calendar layers, where the combining of resources across calendar layers and users avoids displaying duplicate information or information private to a given user and further does display a combination of resources associated with two or more users and two or more calendar layers.

The home screen may also present a prompt for the user and/or collaborators to take a break, wherein the break types may be pre-planned or determined at the time of such an election. A list may be presented on the home screen or in a pop-up window including a plurality of break types including physiological needs associated with the first layer of Maslow's hierarchy of needs: hydration, food, bathroom, exercise, time check, organizational check, etc. The break may allow for other layers of Maslow's hierarchy of needs, as well, with the encouragement of each user to spend at least some time in the self-actualization stage, assessing their discomforts and transmuting them into positive intentions. Each break type may have a suggested duration, wherein one or more users may be encouraged to reconvene after an agreed period of time, and the time frame is either fixed or variable.

For example, the food break may have access to a menu planning, food shopping list or other such lifestyle management resources. It may include a “safe” or “avoid” food list kept in the user's profile, such that it may be shared to those interested in understanding their dietary concerns. It may contain a food shopping list which may be developed with the help of menu planning. The recipes from such a menu may be made available on the home screen during a food preparation time-box, either in a notes section or as a GetToDo. The food break may include weight loss psychological support. It may have mechanisms to encourage built-in exercise, planning and tracking a user's movement. It may encourage a low caloric density or high nutrient density diet, and it may include a calorie counting and/or weight tracking function.

An option may exist to allow the leader of a collaboration or any member of the collaboration to alert all or a subset of collaborators to return to the collaboration. This alert may be set to require an acknowledgement, such that it may become increasingly urgent if not acknowledged.

The break screen may step users through generally well-accepted psychological inquiry and couple's dialogues for improved communication, personal growth and refinement of intentions. Automated couple's dialogues may be provided for impeccable communication. The app may play the role of one side of a dialogue, prompting a single user, or it may play an intermediary, prompting both parties with tips for positive communication. The app may also provide for a “phone-a-friend” option when a user needs support from a trusted friend or family member. This feature of the app may indicate to the user who is likely available at the present moment, allowing them to select for themselves who to contact.

The app may operate on an alternate to the user's main desktop, where multiple desktops are supported. The break screen may allow the user to readily return to their more general (and therefore more distracting) desktop. The general desktop may also be accessible from the home screen through deprecated means, such as on a different screen, within a nested menu, or with a timer. The timer may be set to add a delay before making the general desktop accessible or it may be set to return the user to the home screen and its associated desktop after a certain period. So, when the user enters the Home screen, there may be a deprecated means for accessing the full desktop, but it would not be readily visible. Thus, only the app and the resources the user has selected would be readily available from the home screen. Likewise, notifications would be contextually tailored, at times delayed until a break or a different time-box altogether, and at times allowed to interrupt based upon the user's current stated intentions.

The break types may be from a private or individual reminder list for a specific user or may be from a shared list. (e.g., Individual chore like take out the trash or walk the dog vs. general group break).

The break type may be defined in terms of a plurality of descriptors such as name, duration, description, suggester, picture, activity level, source calendar information, focus level or associated resources (links, files, tools, resources, or allies), where these descriptors may be individual or shared. For example, a break time may be set up from the home screen, whenever the user feels any form of discomfort, or it may be pre-planned. Means may be provided for breaks to be negotiated while the user is in a collaboration.

All user resources will be generally available from the home screen, but potential distractions may be deprecated somehow, forming a commitment device for the user to spend less time doing things they don't feel good about and staying more “on-task” and engaged. A user may need to perform more actions to access a potential distraction, or wait for a timer to expire, for example.

Motion-sensitive context may also be provided for the app when executing on a mobile phone. The app may support co-walking/chatting. It may implement fidget detection to assess a user's emotional state. It may move communications between devices. It may integrate a pedometer into calendar management for built-in exercise and flow. It may optimize the planned trajectory and then observe/predict differences therefrom. In some embodiments there may be deprecated access to the full set of all of these, with user control over the deprecation strategy. It may be: 1) Greyed out, 2) Available only in the settings menu, 3) Pin-protected, 4) Timed access, 5) Stats keeping, 6) Behind a charity pay wall, and/or 7) Behind a friend's permission wall (or parents', for kids).

### (22) Executive Function Enhancement

In the field of computer readable peer-to-peer executive function software, a plurality of communication mechanisms may be utilized to promote enhanced executive function. Executive function software may be defined as that combination of components that help users manage their lives, including all of the following components (not a subset): relationship management, time management, context management, communication, mindfulness, and education.

### Breaks

In one embodiment of the present invention, the app supports the user in taking both planned and unplanned breaks to take care of their body. The app may allow the user to focus on their discomfort during a break and provide a series of questions to prompt the user to work through their discomforts, set or adjust intentions (including making or breaking habits), add or modify GetToDo list items (including tasks, subtasks and/or collaborations) and/or view or adjust day plans. The app may also simply set a timer for the break and either alert the user regarding the end of the break, move the screen focus back to the home screen or both. The app may also provide an incentive for pro-social change in the form of the Halo, as described below.

### (23) Halo: Tokenized Rewards Program

Halo development is envisioned in phases.
Phase 1: First, it will look like a rewards program, where the app provides the rewards.
Phase 2: Secondly, the app will add the ability to share halos, like a tip or thanks for some good work.
Phase 3: Thirdly, the halo will become a form of compensation in the offers and needs marketplace.
Phase 4: Fourth, the halo will become tradeable on Ethereum or similar exchange.

The underlying need for a currency of social benefit such as the halo in the software is the desire for positive social change, in alignment with positive personal habit formation on the part of the app user. Positive habit formation, then, must have two key components:
1. The user must choose the habit, otherwise they would not invest in it
2. There must be a reward for making the changes they choose.

From the point of anyone willing to pay such a reward, a third condition must also apply:
3. The user's chosen habit must also be in alignment with a perceived benefit to both society, as a whole, and to the payer of the reward.

Mining policy, then, will be focused on certain pro-social tasks that they user may perform which are also of benefit to society and to the proliferation of the software. These tasks may include setting up one or more collaborations, adding one or more allies, agreeing to share certain personal data within certain limits within their social fabric or, in some cases, publicly, simply using the app or reading training information about the software and the philosophy behind it. They may also include performing certain tasks, such as first line technical support, in support of both their social fabric and of the software. In some cases, the user may provide the collateral for their own commitment, which is a fairly typical form of commitment device.

Regardless, the app will provide several functions to help the user keep track of not just the habits they want to make, but alongside of them, the habits they want to break, to help specify the actionable steps required in doing so, and then the tracking of each of those steps with a positively reinforcing reward of either simple recognition or a more concrete form of reward such as, for example, a monetary reward of either cash in local currency, a crypto currency or a reward currency of the app similar to frequent flyer mileage plans or credit card usage rewards programs.

The tokenized reward program may also be used to incentivize users for achieving each other's goals. A first user may advertise a need for a given service and the reward that they are willing to offer. A second user may align with this goal and be willing to provide this service in exchange for the stated reward, in which case the two users may form a commitment through the offers and needs marketplace.

Monetary policy regarding the Halo will steer toward slow inflation or “dollar stability”, similar to most major economies, the app may control halo value on a per unit of time basis through mining policy. (We do not want people to have an incentive to hoard the currency, nor do we want prices to escalate at too fast of a clip.) For example, the app might convey that a Halo is worth a minute of one's time, or about a dollar. Initially, due to risk, there may be a par value that makes it worth somewhat less than full value. This par value would adjust upward toward 1 as the system comes on-line and be phased out as the currency becomes tradable. Once it is tradable, the value may be steered by both selling it and taxing transactions.

In some embodiments a monetary policy board or even a third-party entity can set these rates (taxation, mining and target inflation) according to the highest ethical standards that we can envision. We will also want to put measures in place to deter gaming of the system to mine more than an individual's fair share of halos. This may be the single greatest challenge: deterring the bots!

### (24) Coordination Evaluation and Determination Engine

In certain embodiments, the user device executes a coordination evaluation process using parameter values stored locally on the user device. The evaluation is performed in association with a selected ally and uses enumerated parameters including:
1) an intention parameter associated with the current time-box, which in a simplified embodiment comprises a binary value indicating work time or personal time;
2) a focus parameter associated with the current time-box, stored as an enumerated or ordinal value;
3) a relationship type parameter associated with the selected ally; and
4) a trust level parameter associated with the selected ally.

When coordination information, including stored message information, is to be processed in association with the selected ally, the user device: 1) identifies the current time-box, 2) retrieves the intention and focus parameters associated with the current time-box, 3) retrieves the relationship type and trust level associated with the selected ally; and 4) applies a stored rule set, lookup table, conditional logic structure, or scoring function to the retrieved parameters. Responsive to this evaluation, the user device determines whether and how the coordination information is to be accessed, displayed, transmitted, or suppressed.

The determination results in selection of one or more predefined system operations, including: 1) transmitting all, a subset of, or none of the coordination information to the selected ally using peer-to-peer communication, 2) displaying all, a subset of, or none of the coordination information to the user, 3) generating a notification having modified presentation characteristics including timing, prominence, content, or modality, and 4) displaying the selected ally in a prioritized position, a deprioritized position, or not at all within a displayed list of allies.

The evaluation and determination operations are performed entirely on the user device, using the stored enumerated parameters.

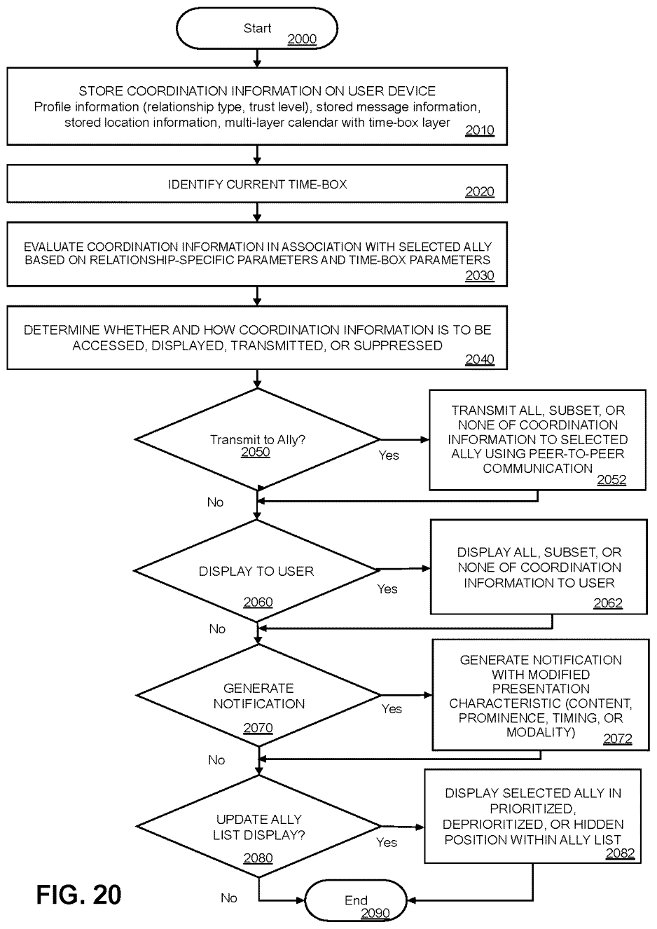

FIG. 20 is a flow chart illustrating a method for coordinating information sharing on a user device, including storing coordination information (STEP 2010), identifying a current time-box (STEP 2020), evaluating coordination information in association with a selected ally based on relationship-specific parameters and time-box parameters (STEP 2030), determining whether and how the coordination information is to be accessed, displayed, transmitted, or suppressed (STEP 2040), and selectively performing one or more system operations including transmitting coordination information to the selected ally (STEP 2052), displaying coordination information to the user (STEP 2062), generating a notification with a modified presentation characteristic (STEP 2072), and updating an ally list display (STEP 2082).

### (25) Exemplary Decision Table for Local Evaluation and Determination

In certain embodiments, the user device determines whether and how coordination information (including message information) is accessed, displayed, transmitted, or suppressed by evaluating the following enumerated parameters:
Intention (I): {Work, Personal}
Focus (F): {Low, Medium, High}
Relationship Type (R): {Family, Friend, Business, Neighbor}
Trust Level (T): {1,2,3,4,5} (or other bounded ordinal scale)

The following table illustrates one non-limiting example mapping from (I, F, R, T) to a determination selecting one or more system operations.

Following are output Enumerations (Determination Results) shown in the Table 1 below:
Transmit (TX): {None, Subset, Full}

Subset may include availability and/or minimal message metadata without message content, depending on embodiment.
Display (DX): {None, Summary, Full}
Notify (NX): {None, Deferred, Modified, Normal}
Ally List Position (LX): {Hide, Deprioritize, Normal, Prioritize}

TABLE 1
Exemplary Decision Mapping

| I (Work/ | F (Low/Med/ | R | T | | | | |
|---|---|---|---|---|---|---|---|
| Personal) | High) | Relationship) | (Trust) | TX | DX | NX | LX |
| Work | High | Business | 1-2 | Subset | None | Deferred | Deprioritize |
| Work | High | Business | 3-5 | Full | Summary | Modified | Normal |
| Work | High | Friend | 1-3 | None | None | None | Hide/ |
| | | | | | | | Deprioritize |
| Work | High | Friend | 4-5 | Subset | Summary | Deferred/ | Normal |
| | | | | | | Modified | |
| Work | High | Family | 1-3 | Subset | Summary | Modified | Prioritize |
| Work | High | Family | 4-5 | Full | Full | Modified/ | Prioritize |
| | | | | | | Normal | |
| Work | Medium | Business | 1-2 | Subset | Summary | Deferred | Normal |
| Work | Medium | Business | 3-5 | Full | Full | Modified/ | Normal |
| | | | | | | Normal | |
| Work | Medium | Friend | 1-3 | Subset/ | Summary/ | Deferred | Deprioritize |
| | | | | None | None | | |
| Work | Medium | Family | 1-5 | Full | Full | Modified/ | Prioritize |
| | | | | | | Normal | |
| Personal | High | Business | 1-3 | None | None | None | Hide/Deprioritize |
| Personal | High | Business | 4-5 | Subset | Summary | Deferred | Deprioritize/Normal |
| Personal | High | Friend | 1-3 | Subset | Summary | Deferred/ | Normal |
| | | | | | | Modified | |
| Personal | High | Friend | 4-5 | Full | Full | Modified/ | Prioritize |
| | | | | | | Normal | |
| Personal | Low/Med | Business | 1-3 | Subset | Summary | Deferred | Deprioritize |
| Personal | Low/Med | Business | 4-5 | Full | Full | Modified/ | Normal |
| | | | | | | Normal | |
| Personal | Low/Med | Friend | 1-5 | Full | Full | Normal | Prioritize |
| Personal | Any | Family | 1-5 | Full | Full | Normal | Prioritize |
| Any | Any | Neighbor | 1-3 | None/Subset | None/Summary | None/Deferred | Hide/Deprioritize |
| Any | Any | Neighbor | 4-5 | Subset | Summary | Deferred/ | Normal |
| | | | | | | Modified | |

“Subset” transmission and “Summary” display are exemplary and may include, in various embodiments, transmitting or displaying message metadata, availability information, or other coordination information without transmitting or displaying message content. The specific thresholds and mappings shown are non-limiting examples, and other stored rule sets, lookup tables, or scoring functions may be used while remaining within the disclosed evaluation framework.

### (26) Exemplary Evaluation Flow

In one exemplary embodiment, the user device processes stored message information received from a selected ally as follows:
1) The user device identifies the current time-box.
2) The intention parameter associated with the current time-box is retrieved (e.g., Work).
3) The focus parameter (level) associated with the current time-box is retrieved (e.g., High).
4) The relationship type associated with the selected ally is retrieved (e.g., Business).
5) The trust level associated with the selected ally is retrieved (e.g., 2).
6) The retrieved parameter values are applied to a stored decision table.
7) Based on the decision table, the system determines that transmission is limited to a subset, display is suppressed, notification is deferred, and the ally is deprioritized in the ally list.
8) The user device then selectively performs the corresponding system operations.

### Programmable Embodiments

Some or all aspects of the invention, for example aspects of the algorithmic characteristics of the invention, may be implemented in hardware or software, or a combination of both (e.g., programmable logic arrays). Unless otherwise specified, the algorithms included as part of the invention are not inherently related to any particular computer or other apparatus. In particular, various general purpose computing machines may be used with programs written in accordance with the teachings herein, or it may be more convenient to use a special purpose computer or special-purpose hardware (such as integrated circuits) to perform particular functions. Thus, embodiments of the invention may be implemented in one or more computer programs (i.e., a set of instructions or codes) executing on one or more programmed or programmable computer systems (which may be of various architectures, such as distributed, client/server, or grid) each comprising at least one processor, at least one data storage system (which may include volatile and non-volatile memory and/or storage elements), at least one input device or port, and at least one output device or port. Program instructions or code may be applied to input data to perform the functions described in this disclosure and generate output information. The output information may be applied to one or more output devices in known fashion.

Each such computer program may be implemented in any desired computer language (including machine, assembly, or high-level procedural, logical, or object-oriented programming languages) to communicate with a computer system, and may be implemented in a distributed manner in which different parts of the computation specified by the software are performed by different computers or processors. In any case, the computer language may be a compiled or interpreted language. Computer programs implementing some or all of the invention may form one or more modules of a larger program or system of programs. Some or all of the elements of the computer program can be implemented as data structures stored in a computer readable medium or other organized data conforming to a data model stored in a data repository.

Each such computer program may be stored on or downloaded to (for example, by being encoded in a propagated signal and delivered over a communication medium such as a network) a tangible, non-transitory storage media or device (e.g., solid state memory media or devices, or magnetic or optical media) for a period of time (e.g., the time between refresh periods of a dynamic memory device, such as a dynamic RAM, or semi-permanently or permanently), the storage media or device being readable by a general or special purpose programmable computer or processor for configuring and operating the computer or processor when the storage media or device is read by the computer or processor to perform the procedures described above. The inventive system may also be considered to be implemented as a non-transitory computer-readable storage medium, configured with a computer program, where the storage medium so configured causes a computer or processor to operate in a specific or predefined manner to perform the functions described in this disclosure.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping but rather should be read as “and/or” unless expressly stated otherwise. Similarly, a group of items linked with the conjunction “or” should not be read as requiring mutual exclusivity among that group but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented coordination system comprising:
a user device including at least one processor and a non-transitory computer-readable medium storing instructions that, when executed by the at least one processor, cause the user device to:
store coordination information associated with a user, the coordination information including:
profile information including relationship-specific parameters for a plurality of allies, the relationship-specific parameters including, for each ally a relationship type and a trust level;
stored message information; and
a multi-layer calendar stored on the user device, the multi-layer calendar including a time-box layer defining a plurality of time-boxes collectively forming a day plan for the user, each time-box including
time-box parameters defining a contextual state of the user during that time-box, the time-box parameters including an associated intention, and an associated focus level,
wherein, at any given time within the day plan, one and only one time-box is applicable to the user;
identify a current time-box of the plurality of time-boxes;
evaluate coordination information in association with a selected ally based at least on the relationship-specific parameters associated with the selected ally; and the time-box parameters associated with the current time-box;
determine, responsive to the evaluation, whether and how the coordination information is to be accessed, displayed, transmitted, or suppressed;
wherein the evaluation and the determination are performed entirely on the user device;
and selectively perform, by the user device based on the determination, at least one system operation comprising one or more of:
transmitting all, a subset of, or none of the coordination information or information derived therefrom to the selected ally using peer-to-peer communication;
displaying all, a subset of, or none of the coordination information or information derived therefrom to the user;
generating a notification to the user regarding the coordination information or information derived therefrom, the notification having a modified presentation characteristic including at least one of content, prominence, timing, or modality; and
displaying the selected ally in a prioritized position, a deprioritized position, or not at all within a displayed list of allies on the user device.

2. The system of claim 1, wherein the coordination information includes availability information derived from the time-box layer, the availability information being distinct from full calendar event information.

3. The system of claim 2, wherein the at least one system operation selectively transmits to the selected ally, responsive to the relationship-specific parameters, at least one of:
full calendar event information;
availability information without event detail; and
no calendar-related information.

4. The system of claim 1, wherein calendar-related information transmitted to different allies differs according to their respective relationship-specific parameters.

5. The system of claim 2, wherein said evaluation, for the selected ally and for the identified time-box, determines an ally-specific availability state based on the intention associated with the identified time-box and the relationship type associated with the selected ally.

6. The system of claim 1, wherein said evaluation, for the selected ally and for the identified time-box, determines an ally-specific interruptability level based on the relationship type associated with the selected ally and the intention associated with the identified time-box, and controls whether synchronous communication from the selected ally is presented immediately, modified, or deferred responsive to the determined ally-specific interruptability level.

7. The system of claim 1, wherein the stored message information includes a message associated with the user, and wherein the determination determines, for the selected ally, whether and how the message is transmitted to a selected ally device or displayed on the user device.

8. The system of claim 1, wherein the time-box parameters further include:
an interruptability level associated with the time-box, the interruptability level being either an independently defined time-box parameter, or derived from one or more other time-box parameters; and
wherein the at least one system operation suppresses generation of the notification during a time-box having low interruptability level.

9. The system of claim 8, wherein the notification is deferred for presentation during a time-box having higher interruptability.

10. The system of claim 8, wherein at least one of timing, modality, or prominence of the notification is altered responsive to the interruptability level associated with the identified time-box.

11. The system of claim 8, wherein timing, modality, or prominence of the notification escalates from a first notification level during a first time-box having lower interruptability level to a second notification level during a subsequent time-box having higher interruptability level.

12. The system of claim 1, wherein the coordination information includes offer information or need information associated with the user.

13. The system of claim 12, wherein the offer information or need information further includes visibility metadata specifying one or more relationship types or trust levels permitted to access the offer information or need information.

14. The system of claim 13, wherein transmission of the offer information or need information to the selected ally is permitted only if the relationship-specific parameters of the selected ally satisfy the visibility metadata.

15. The system of claim 1, wherein the time-box layer includes at least one stored day plan template defining a plurality of time-boxes reusable across multiple calendar days.

16. The system of claim 15, wherein the system assigns a selected day plan template as a default for one or more days of the week and permits the default assignment to be overridden for a specific calendar day or date range.

17. The system of claim 1, wherein the multi-layer calendar further includes an event layer distinct from the time-box layer.

18. The system of claim 1:
wherein the profile information associated with the user further includes first stored location information and the profile information associated with the selected ally further includes second stored location information;
wherein said evaluation further comprises evaluating proximity between the user and the selected ally based at least in part on the first stored location information and the second stored location information in combination with the relationship-specific parameters associated with the selected ally and the time-box parameters associated with the current time-box; and
wherein said determination of whether and how the coordination information is accessed, displayed, transmitted, or suppressed is further responsive to the evaluated proximity.

19. A computer-implemented method for coordinating information sharing on a user device, the user device including at least one processor and a non-transitory computer-readable medium, the method comprising:
storing, on the user device, coordination information associated with a user, the coordination information including:
profile information including relationship-specific parameters for a plurality of allies, the relationship-specific parameters including, for each ally, a relationship type and a trust level;
stored message information; and
a multi-layer calendar including a time-box layer defining a plurality of time-boxes collectively forming a day plan for the user, each time-box including time-box parameters defining a contextual state of the user during that time-box, the time-box parameters including an associated intention and an associated focus level,
wherein, at any given time within the day plan, one and only one time-box is applicable to the user;
identifying, by the at least one processor, a current time-box of the plurality of time-boxes;
evaluating, by the at least one processor, coordination information in association with a selected ally based at least on the relationship-specific parameters associated with the selected ally and the time-box parameters associated with the current time-box;
determining, by the at least one processor and responsive to the evaluating, whether and how the coordination information is to be accessed, displayed, transmitted, or suppressed;
wherein the evaluating and the determining are performed entirely on the user device; and
selectively performing, by the user device based on the determining, at least one system operation comprising one or more of:
transmitting all, a subset of, or none of the coordination information or information derived therefrom to the selected ally using peer-to-peer communication;
displaying all, a subset of, or none of the coordination information or information derived therefrom to the user;
generating a notification to the user regarding the coordination information or information derived therefrom, the notification having a modified presentation characteristic including at least one of content, prominence, timing, or modality; and
displaying the selected ally in a prioritized position, a deprioritized position, or not at all within a displayed list of allies on the user device.

20. A non-transitory computer-readable medium storing instructions that, when executed by at least one processor of a user device, cause the user device to perform operations comprising:
storing coordination information associated with a user, the coordination information including:
profile information including relationship-specific parameters for a plurality of allies, the relationship-specific parameters including, for each ally, a relationship type and a trust level;
stored message information; and
a multi-layer calendar including a time-box layer defining a plurality of time-boxes collectively forming a day plan for the user, each time-box including time-box parameters defining a contextual state of the user during that time-box, the time-box parameters including an associated intention and an associated focus level,
wherein, at any given time within the day plan, one and only one time-box is applicable to the user;
identifying a current time-box of the plurality of time-boxes;
evaluating coordination information in association with a selected ally based at least on the relationship-specific parameters associated with the selected ally and the time-box parameters associated with the current time-box;
determining, responsive to the evaluating, whether and how the coordination information is to be accessed, displayed, transmitted, or suppressed;
wherein the evaluating and the determining are performed entirely on the user device; and
selectively performing, based on the determining, at least one system operation comprising one or more of:
transmitting all, a subset of, or none of the coordination information or information derived therefrom to the selected ally using peer-to-peer communication;
displaying all, a subset of, or none of the coordination information or information derived therefrom to the user;
generating a notification to the user regarding the coordination information or information derived therefrom, the notification having a modified presentation characteristic including at least one of content, prominence, timing, or modality; and
displaying the selected ally in a prioritized position, a deprioritized position, or not at all within a displayed list of allies on the user device.
